(19) United States
(12) Patent Application Publication
(10) Pub. No.: US 2016/0378743 A1
(43) Pub. Date: Dec. 29, 2016

(54) METHOD AND APPARATUS FOR INSERTION OF TEXT IN AN ELECTRONIC DEVICE

(71) Applicant: Samsung Electronics Co., Ltd., Suwon-si (KR)

(72) Inventors: Sumit KUMAR, Rohtak (IN); Brij Mohan PUROHIT, Dehradun (IN); Shubham JOSHI, Mukhani (IN)

(21) Appl. No.: 15/167,046

(22) Filed: May 27, 2016

(30) Foreign Application Priority Data
Jun. 29, 2015 (IN) 1944/DEL/2015

(51) Int. Cl. G06F 17/24; G06F 3/0483; G06F 3/0488; G06F 3/0484

(52) U.S. Cl. CPC G06F 17/243; G06F 3/04842; G06F 3/0483; G06F 3/04883

(57) ABSTRACT

A method and apparatus for automatically performing an activity involving insertion of text and navigation between a plurality of electronic pages is provided. The method for automatic insertion of text into an electronic page in an electronic device includes detecting a selection of an electronic file having information comprising text data corresponding to the at least one form user interface (UI) element of an electronic page and a link to the electronic page, and obtaining the electronic page in a state that the at least one form UI element is filled with the text data.

### PRIORITY

This application claims the benefit under 35 U.S.C. §119(a) of an Indian patent application filed in the Indian Patent Office on Jun. 29, 2015 and assigned Serial No. 1944/DEL/2015, the entire disclosure of which is hereby incorporated by reference.

### TECHNICAL FIELD

The present invention in general relates to performing an electronic activity automatically. More particularly, the present invention relates to automatic insertion of text in electronic page and automatic navigation between a plurality of electronic pages.

### BACKGROUND

Many applications or websites that can run on a variety of computing devices allow users to enter text data in text boxes displayed on a graphical user interface. In order to facilitate text inputs from the user, an autofill functionality is generally provided. To this end, there are existing solutions that understand text inputs written directly on the graphical user interface by a user. Furthermore, some existing solutions are capable of scanning a physical document with optical character recognition capabilities.

In one known method, a scanned paper using well-defined handwritten annotations can trigger computer applications on a PC and provide data from the scanned paper to the triggered computer applications. In another known method, image based task execution requires an image of an unprocessed document, such as a railway ticket, airline boarding pass etc., as an input to an authoring application. In another known method, a computer peripheral apparatus may be provided for connecting to a computer. The computer peripheral apparatus performs tasks according to user input image file, while an optical character recognition program directly recognize characters included in the image file. In another known method, a user is provided with an image area upon which a request-response communication takes place. This leads to recognizing input handwriting in an image and execute an application/task based on the written command or response.

So existing solutions may provide automated input of some data, however, these methods may still be deficient and therefore, unable to meet the many needs of today's Internet user when it comes to eliminating redundant activities performed on computing devices.

### SUMMARY

In accordance with the purposes of the present invention, the present invention as embodied and broadly described herein, enables an end-user to automate electronic activities that are repeatedly executed in a computing device, such as a laptop, desktop, smartphone, etc. More specifically, the present invention enables the end-user to provide parameter values in an electronic page over a screenshot of the electronic page. For instance, text data corresponding to various form elements of the electronic page may be provided over the screenshot of the electronic page. This is referred to as an activity state hereinafter. The present invention also enables to bind such an activity state with an action to be performed on a GUI element in the electronic page. All this additional information, i.e., parameter values, action to be taken, and activity information is stored or associated with said screenshot in form of an active image file. This active image file can be later executed by an active image processor upon instruction from the end user to directly load a resultant activity through a link to the electronic page associated with the image file, i.e., without requiring parameter values and action information again.

Few of the many advantages of the present invention are that it can save resources and internet data consumption, while enriching overall user experience. More specifically, it can save operating system resources for some huge applications that the user frequently accesses to perform same task with the same query. This approach provides the user a figurative shortcut to move directly to a specific activity with bypassing the redundant activities. This approach can save the internet data consumption at the time of launching an application, as many applications at the start require to have a data connection to move from one app activity to the other. Such data consumption can be avoided when the present invention is employed. Using the present invention, the user can send a consolidated query, upon launching said electronic file, to either a local/in-house controller or a remotely located controller, and hence direct the local application to open a specific activity thus avoiding the data required to load the content on the redundant activities. Furthermore, the user is given an ease of access to a quick reference activity state, parameter values, and action—available as a combination in the form of active images saved on the mobile phone's gallery. This provides a very intuitive and effective method for the end-user to have the benefits of a quick-reference to a specific task. Further, the present invention provides additional capabilities in various peer-to-peer communication as well as client-server communication scenarios. Accordingly, the present invention can have applicability in multiple domains. These aspects and advantages will be more clearly understood from the following detailed description taken in conjunction with the accompanying drawings and claims.

In one embodiment, a method for automatic insertion of text into an electronic page in an electronic device comprises detecting a selection of an electronic file having information comprising text data corresponding to the at least one form UI element of an electronic page and a link to the electronic page, and obtaining the electronic page in a state that the at least one form UI element that is filled with the text data.

In another embodiment, an apparatus for automatic insertion of text into an electronic page in an electronic device comprises a processor. The processor is configured to control to detect a selection of an electronic file having information comprising a link to an electronic page and text data corresponding to the at least one form user interface (UI) element of the electronic page, and obtain an electronic page in a state that the at least one form UI element that is filled with the text data.

### BRIEF DESCRIPTION OF THE DRAWINGS

For further clarifying advantages and aspects of the present invention, a more particular description of the present invention will be rendered by reference to specific embodiments thereof, which is illustrated in the appended drawings. It is appreciated that these drawings depict only typical embodiments of the present invention and are therefore not to be considered limiting of its scope. The present invention will be described and explained with additional specificity and detail with the following figures, wherein:

FIG. 1A illustrates a method for defining automatic insertion of text in an electronic page having at least one form element, in accordance with an embodiment of the present invention.

FIG. 1B illustrates a method for defining automatic insertion of text in an electronic page having at least one form element, in accordance with an embodiment of the present invention.

FIG. 1C illustrates a method for automatic insertion of text in an electronic page having at least one form element, in accordance with an embodiment of the present invention.

FIG. 1D illustrates a method for automatic insertion of text in an electronic page having at least one form element, in accordance with an embodiment of the present invention.

FIG. 1E illustrates a method for automatically performing an activity involving insertion of text and navigation between a plurality of electronic pages, in accordance with an embodiment of the present invention.

FIG. 2A illustrates a computing device to implement aforementioned methods, in accordance with an embodiment of the present invention.

FIG. 2B illustrates a computer network environment to implement aforementioned methods.

FIGS. 3A to 3D illustrate few exemplary uses of the present invention.

FIG. 4 illustrates how an activity is performed automatically as per the present invention.

FIG. 5 illustrates how a mobile recharge activity is performed in state of the art.

FIGS. 6 to 9 illustrate how a page of mobile recharge activity is automated as per the present invention.

FIGS. 10 to 12 illustrate how a mobile recharge activity is performed automatically as per the present invention.

FIGS. 13 to 16 illustrate how subsequent activities are automated and then performed automatically as per the present invention.

FIGS. 17 to 21 illustrate the use of present invention in an exemplary file sharing scenario.

FIGS. 22 to 24 illustrate the use of present invention in an exemplary contact dialing scenario.

FIGS. 25A to 25C illustrate a flow chart for saving an image state as per the present invention.

FIGS. 26A and 26B illustrate a flow chart for executing an active image as per the present invention.

FIG. 27 illustrates all the activities typically involved for recharging a prepaid mobile.

FIG. 28 illustrates saving an image state for recharging a prepaid mobile as per the present invention.

FIG. 29 illustrates executing an active image for recharging a prepaid mobile as per the present invention.

FIG. 30 illustrates an alarm clock activity as performed in state of the art.

FIG. 31 illustrates an alarm clock activity as performed as per the present invention.

FIGS. 32 to 34 illustrate another exemplary use of present invention for sending an instant message.

FIGS. 35 to 39 illustrate another exemplary use of present invention involving usage of Floating Action Buttons.

FIG. 40 illustrates a text file for automatic insertion of text in an electronic page in an embodiment of the present invention.

It may be noted that to the extent possible, like reference numerals have been used to represent like elements in the drawings. Further, those of ordinary skill in the art will appreciate that elements in the drawings are illustrated for simplicity and may not have been necessarily drawn to scale. For example, the dimensions of some of the elements in the drawings may be exaggerated relative to other elements to help to improve understanding of aspects of the present invention. Furthermore, the one or more elements may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION

It should be understood at the outset that although illustrative implementations of the embodiments of the present disclosure are illustrated below, the present invention may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching and illuminating some embodiments and their specific features and elements and does not limit, restrict or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having an ordinary skill in the art.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfill the requirements of uniqueness, utility and non-obviousness.

Use of the phrases and/or terms such as but not limited to “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or variants thereof do NOT necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should NOT be necessarily taken as limiting factors to the attached claims. The attached claims and their legal equivalents can be realized in the context of embodiments other than the ones used as illustrative examples in the description below.

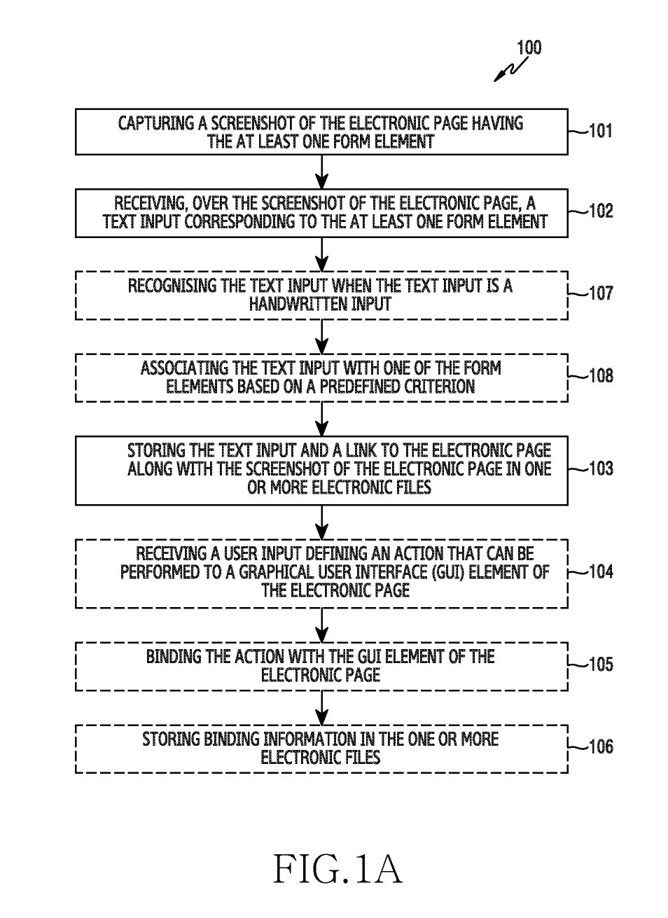

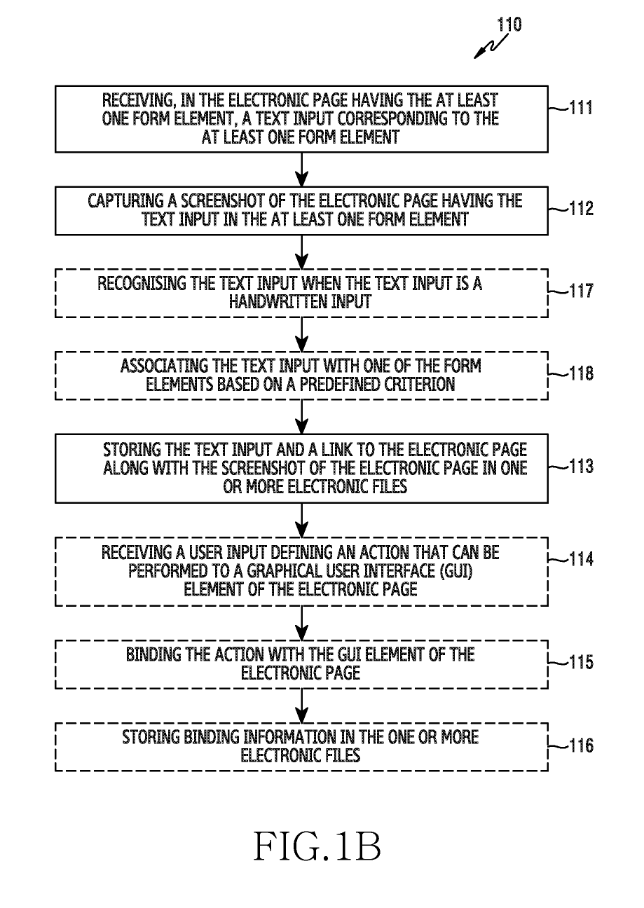

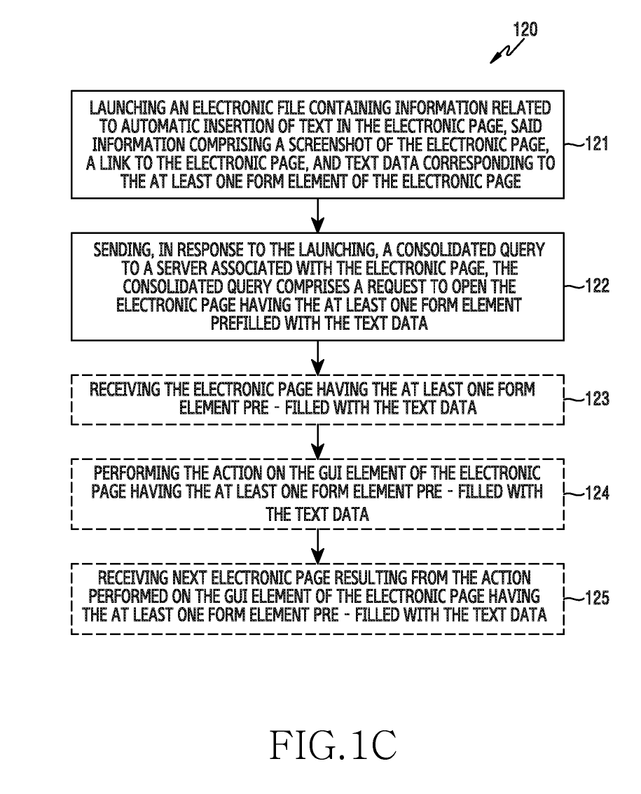

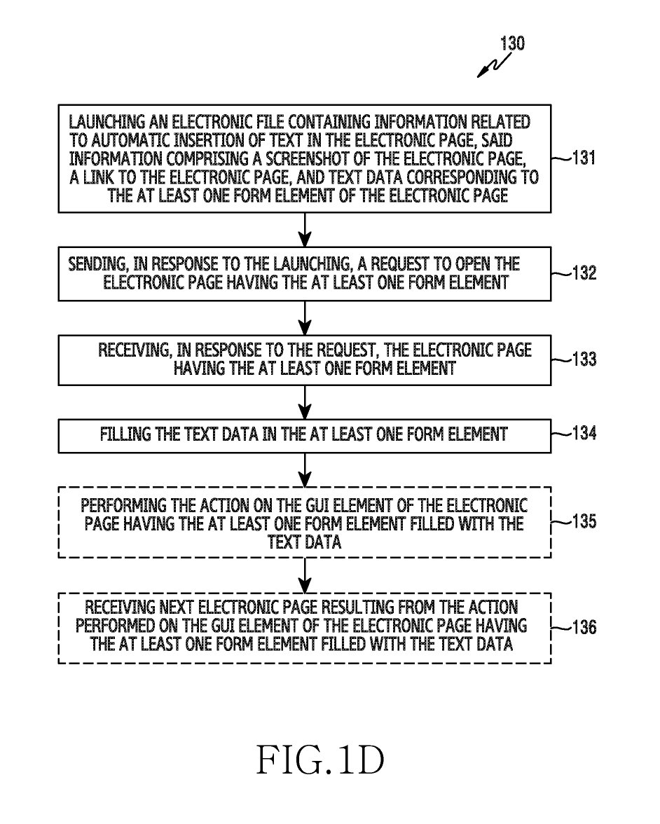

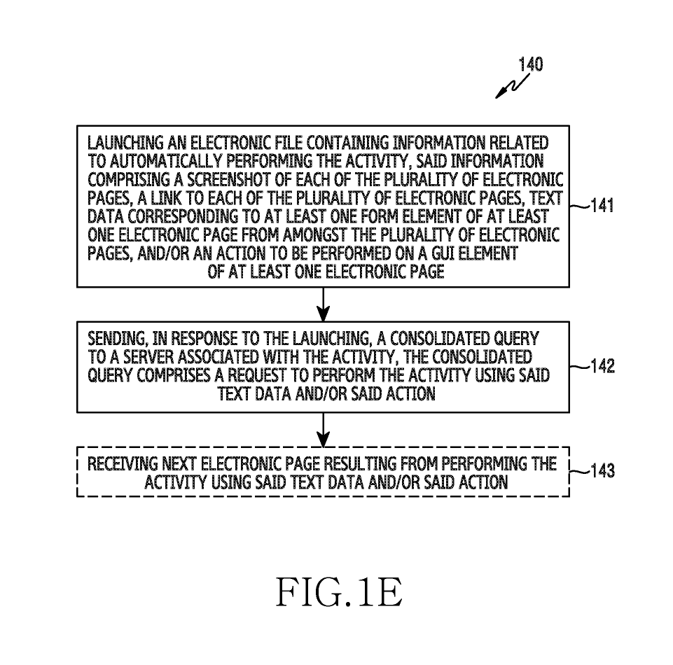

In one embodiment, FIG. 1A illustrates a method 100 implemented in a computing device for defining automatic insertion of text in an electronic page having at least one form element, the method comprising: capturing 101 a screenshot of the electronic page having the at least one form element; receiving 102, over the screenshot of the electronic page, a text input corresponding to the at least one form element; and storing 103 the text input and a link to the electronic page along with the screenshot of the electronic page in one or more electronic files.

In an alternative embodiment, FIG. 1B illustrates a method 110 implemented in a computing device for defining automatic insertion of text in an electronic page having at least one form element, the method comprising: receiving 111, in the electronic page having the at least one form element, a text input corresponding to the at least one form element; capturing 112 a screenshot of the electronic page having the text input in the at least one form element; and storing 113 the text input and a link to the electronic page along with the screenshot of the electronic page in one or more electronic files.

In a further embodiment, the methods 100 and 110 comprise: receiving 104,114 a user input defining an action that can be performed to a graphical user interface (GUI) element of the electronic page; binding 105, 115 the action with the GUI element of the electronic page; and storing 106, 116 binding information in the one or more electronic files.

In a further embodiment, the action can be single click, multiple clicks, long press, single tap, multiple taps, swipe, eye gaze, air blow, hover, air view, or a combination thereof.

In a further embodiment, the receiving 102, 111 comprises filling the text input in the at least one form element while the electronic page is active.

In a further embodiment, the storing 103, 113 comprises storing the screenshot along with additional information as metadata of the screenshot in a single electronic file.

In a further embodiment, the storing 103, 113 comprises storing the screenshot in a first electronic file and storing additional information in a second electronic file in a database, and wherein the second electronic file is linked to the first electronic file, wherein the first and the second electronic file can be stored at same device or at different devices.

In a further embodiment, the storing 103, 113 is performed upon receiving a user selection on a storing option.

In a further embodiment, the electronic page is an application-page or a web-page or an instance of an application.

In a further embodiment, the methods 100 and 110 comprise: recognizing 107, 117 the text input when the text input is a handwritten input; and associating 108, 118 the text input with one of the form elements based on a predefined criterion.

In a further embodiment, the predefined criterion is based on selection of the at least one form element, proximity of the text input to the at least one form element, type of the text input, content of text input, or a combination thereof.

In one embodiment as shown in FIG. 1C, the present invention provides a method 120 implemented in a computing device for automatic insertion of text in an electronic page having at least one form element, the method 120 comprising: launching 121 an electronic file containing information related to automatic insertion of text in the electronic page, said information comprising a screenshot of the electronic page, a link to the electronic page, and text data corresponding to the at least one form element of the electronic page; and sending 122, in response to the launching, a consolidated query to a local/in-house controller or a remotely placed controller associated with the electronic page, the consolidated query comprises a request to open the electronic page having the at least one form element pre-filled with the text data.

In a further embodiment, the method 120 comprises: receiving 123 the electronic page having the at least one form element pre-filled with the text data.

In a further embodiment, said information further comprises an action that can be performed to a GUI element of the electronic page.

In a further embodiment, the action can be single click, multiple clicks, long press, single tap, multiple taps, swipe, eye gaze, air blow, hover, air view, or a combination thereof.

In a further embodiment, the method 120 comprises: performing 124 the action on the GUI element of the electronic page having the at least one form element pre-filled with the text data.

In a further embodiment, the method 120 comprises: receiving 125 next electronic page resulting from the action performed on the GUI element of the electronic page having the at least one form element pre-filled with the text data.

In one embodiment as shown in FIG. 1D, the present invention provides a method 130 implemented in a computing device for automatic insertion of text in an electronic page having at least one form element, the method comprising: launching 131 an electronic file containing information related to automatic insertion of text in the electronic page, said information comprising a screenshot of the electronic page, a link to the electronic page, and text data corresponding to the at least one form element of the electronic page; sending 132, in response to the launching, a request to open the electronic page having the at least one form element; receiving 133, in response to the request, the electronic page having the at least one form element; and filling 134 the text data in the at least one form element.

In a further embodiment, said information further comprises an action that can be performed to a GUI element of the electronic page.

In a further embodiment, the action can be single click, multiple clicks, long press, single tap, multiple taps, swipe, eye gaze, air blow, hover, air view, or a combination thereof.

In a further embodiment, the method 130 comprises: performing 135 the action on the GUI element of the electronic page having the at least one form element filled with the text data.

In a further embodiment, the method 130 comprises: receiving 136 next electronic page resulting from the action performed on the GUI element of the electronic page having the at least one form element filled with the text data.

In one embodiment as shown in FIG. 1E, the present invention provides a method 140 implemented in a computing device for automatically performing an activity involving insertion of text and navigation between a plurality of electronic pages, the method comprising: launching 141 an electronic file containing information related to automatically performing the activity, said information comprising a screenshot of each of the plurality of electronic pages, a link to each of the plurality of electronic pages, text data corresponding to at least one form element of at least one electronic page from amongst the plurality of electronic pages, and/or an action to be performed on a GUI element of at least one electronic page; and sending 142, in response to the launching, a consolidated query to a server (or local/remotely located controller) associated with the activity, the consolidated query comprises a request to perform the activity using said text data and/or said action.

In a further embodiment, the method 140 comprises: receiving 143 next electronic page resulting from performing the activity using said text data and/or said action.

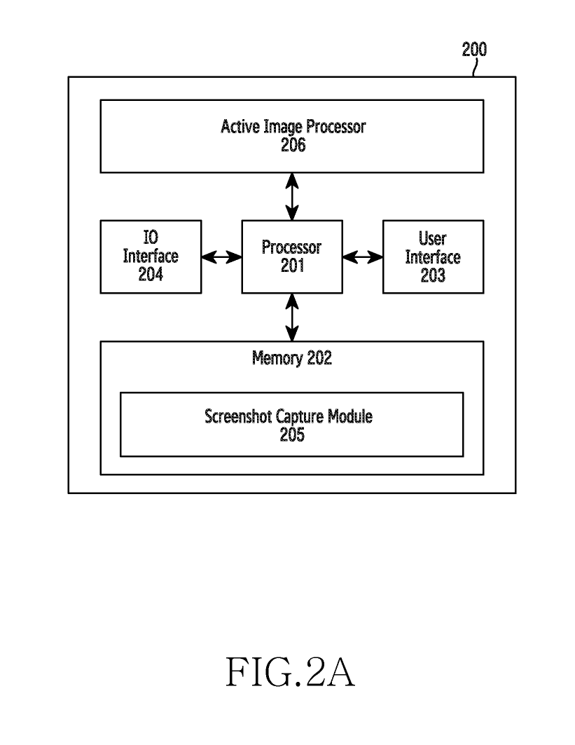

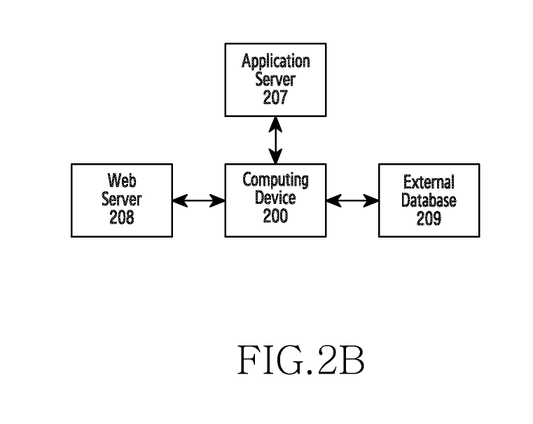

FIG. 2A illustrates a computing device 200 for executing the methods described in previous paragraphs. The computing device 200 comprises one or more of a processor 201, a memory 202, a user interface 203, an Input Output (IO) interface 204, a screenshot capture module 205, an active image processor 206, etc. The IO interface 204 may be a transceiver.

In one embodiment, the present invention provides a computing device 200 for defining automatic insertion of text in an electronic page having at least one form element, the computing device comprising: a processor 201; a screenshot capturing module 205 configured to capture a screenshot of the electronic page having the at least one form element; a user interface 203 configured to receive, over the screenshot of the electronic page, a text input corresponding to the at least one form element; and a memory 202 configured to store the text input and a link to the electronic page along with the screenshot of the electronic page in one or more electronic files.

In an alternative embodiment, the present invention provides a computing device 200 for defining automatic insertion of text in an electronic page having at least one form element, the computing device comprising: a processor 201; a user interface 203 configured to receive, in the electronic page having the at least one form element, a text input corresponding to the at least one form element; a screenshot capturing module 205 configured to capture a screenshot of the electronic page having the text input in the at least one form element; and a memory 202 configured to store the text input and a link to the electronic page along with the screenshot of the electronic page in one or more electronic files.

In a further embodiment, the user interface 203 is configured to receive a user input defining an action that can be performed to a graphical user interface (GUI) element of the electronic page; the processor 201 is configured to bind the action with the GUI element of the electronic page; and the memory 202 is configured to store binding information in the one or more electronic files.

In one embodiment, the present invention provides a computing device 200 for automatic insertion of text in an electronic page having at least one form element, the computing device comprising: a processor 201; a memory 202 coupled to the processor 201; a user interface 203 configured to launch an electronic file containing information related to automatic insertion of text in the electronic page, said information comprising a screenshot of the electronic page, a link to the electronic page, and text data corresponding to the at least one form element of the electronic page; and an IO interface 204 configured to send, in response to the launch of the electronic file, a consolidated query to a server (or local/remotely located controller) associated with the electronic page, the consolidated query comprises a request to open the electronic page having the at least one form element pre-filled with the text data.

In a further embodiment, the IO interface 204 is configured to receive the electronic page having the at least one form element pre-filled with the text data.

In a further embodiment, said information further comprises an action that can be performed to a GUI element of the electronic page.

In a further embodiment, the processor 201 is configured to perform the action on the GUI element of the electronic page having the at least one form element pre-filled with the text data.

In a further embodiment, the IO interface 204 is configured to receive next electronic page resulting from the action performed on the GUI element of the electronic page having the at least one form element pre-filled with the text data.

In one embodiment, the present invention provides a computing device 200 for automatic insertion of text in an electronic page having at least one form element, the computing device comprising: a user interface 203 configured to launch an electronic file containing information related to automatic insertion of text in the electronic page, said information comprising a screenshot of the electronic page, a link to the electronic page, and text data corresponding to the at least one form element of the electronic page; an IO interface 204 configured to send, in response to the launch of the electronic file, a request to open the electronic page having the at least one form element, and configured to receive, in response to the request, the electronic page having the at least one form element; and a processor 201 configured to fill the text data in the at least one form element.

In one embodiment, the present invention provides a computing device 200 for automatically performing an activity involving insertion of text and navigation between a plurality of electronic pages, the computing device comprising: a processor 201; a memory 202 coupled to the processor 201; a user interface 203 configured to launch an electronic file containing information related to automatically performing the activity, said information comprising a screenshot of each of the plurality of electronic pages, a link to each of the plurality of electronic pages, text data corresponding to at least one form element of at least one electronic page from amongst the plurality of electronic pages, and/or an action to be performed on a GUI element of at least one electronic page; an IO interface 204 configured to send, in response to the launch of the electronic file, a consolidated query to a server (or local/remotely located controller) associated with the activity, the consolidated query comprises a request to perform the activity using said text data and/or said action.

In a further embodiment, the IO interface 204 is configured to receive next electronic page resulting from performing the activity using said text data and/or said action.

FIG. 2B illustrates a computer network environment for executing the methods described in previous paragraphs. In this computer network environment, the computing device 200 can interact with other devices through its IO interface 204. For example, the computing device can send a query to a server, such as an application server 208 or a web server 209. Such server may also be understood to encompass or refer a local or a remotely placed controller. Similarly, the computing device can receive a response from the server. Further, the computing device 200 can either locally store the additional information associated with a screenshot of underlying activity or store it on an external database 209. In later case, whenever the active image processor 206 of the computing device 200 needs to execute an active image, the computing device 200 can fetch the additional information from the external database 209.

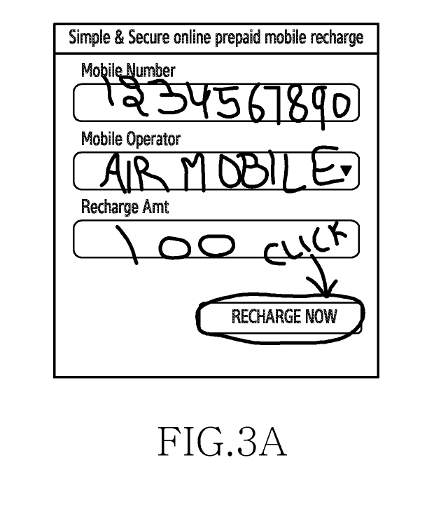

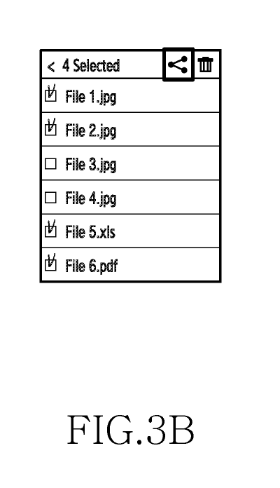

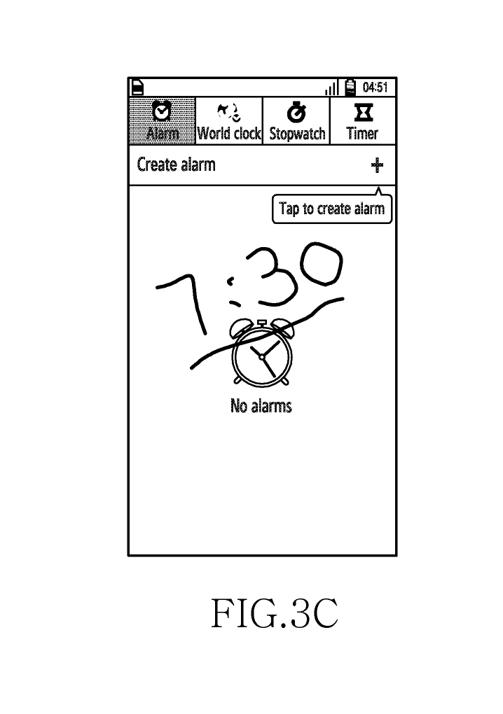

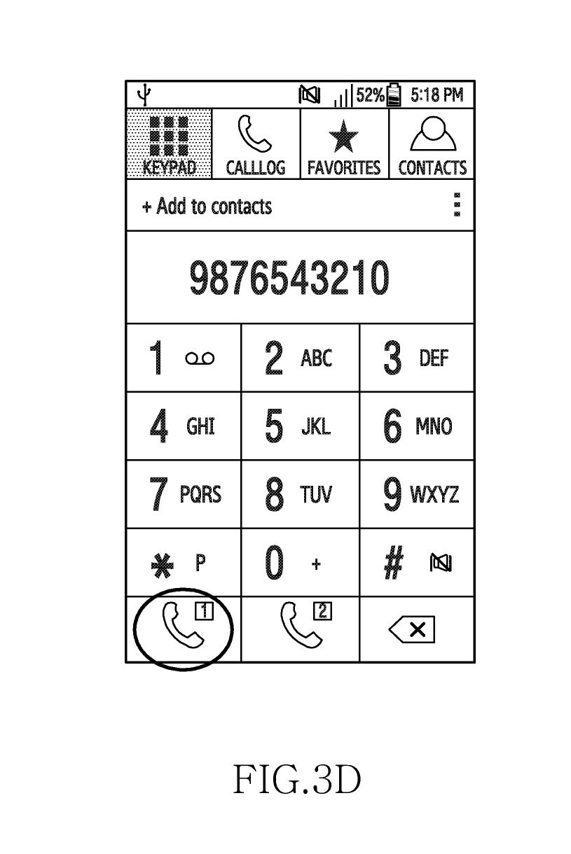

FIGS. 3A to 3D illustrate exemplary uses of the present invention. This invention allows the user to do many tasks in steps, which are as easy as scrolling through a gallery of images. For instance using the present invention, a user will be able to recharge mobile phone as shown in FIG. 3A, send specific files as shown in FIG. 3B, set alarm as shown in FIG. 3C, dial phone numbers as shown in FIG. 3D, etc. All of these exemplary activities can be performed relatively quickly as compared to how they are performed in state of the art because redundant steps can be totally eliminated. All that is required is an active image for each of these activities. In one implementation, the active image may be stored in one or more files having any relevant file extension, such as .jpg, .jpeg, .gif, .active, etc. The active image is basically a screenshot of a particular activity with some additional information that can be executed. Here, the additional information includes, but is not limited to a link to the activity itself, values of state parameters, and one or more actions to be taken on a state. The aforementioned exemplary uses will be explained in more detail in subsequent paragraphs.

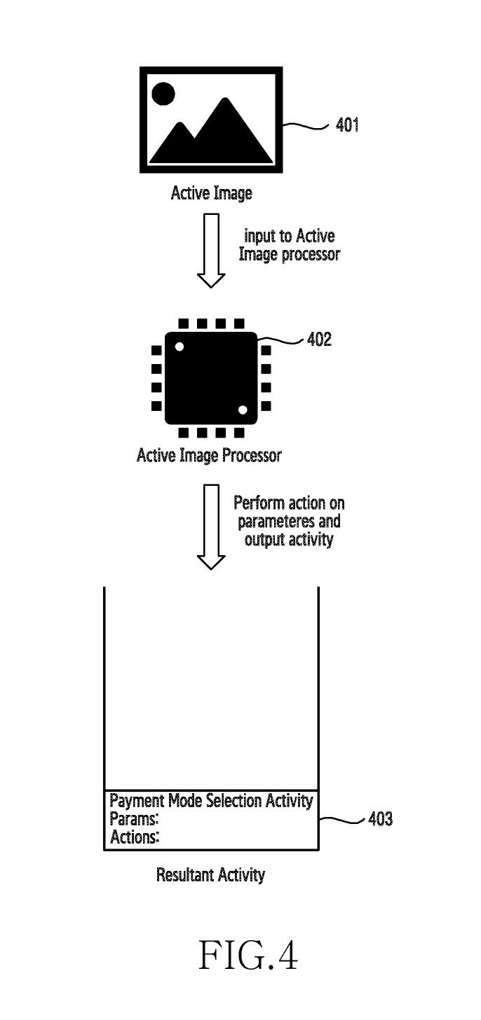

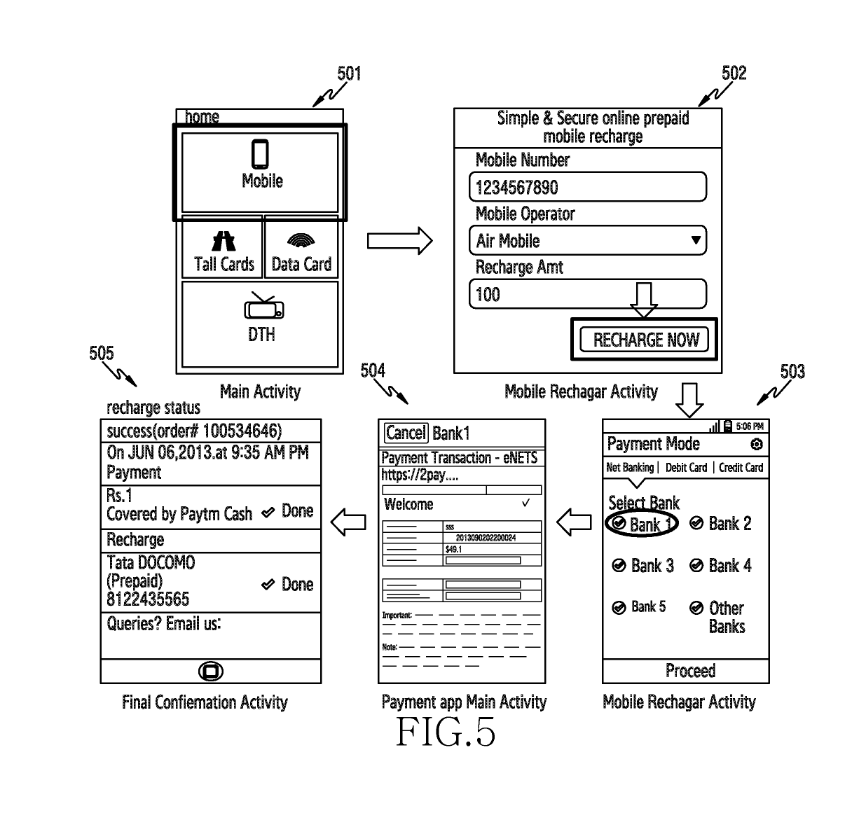

Before that, the basic concept behind the working of present invention may be understood with the help of FIG. 4. Once an active image (401) is generated for an activity, it may launched anytime by a user, for example, through gallery or file explorer. After active image is launched, an active image processor (402) processes the active image to parse the additional information associated with the active image. This active image processor may be implemented as a dedicated hardware, software, or combination thereof in state of the art computing devices. The active image processor then performs a pre-configured action using the stored parameter value and loads an output activity (403) on the screen.

To simplify, this invention works in two main steps. The first step is to save the parameters in a state while the second step is to bind an action corresponding to the preserved state. However, having a binding action with the preserved state is not mandatory as an active image file can just keep state/parameters with reference to an activity. The same can be retrieved later on without the user having to proceed with pre-configured subsequent action. At the same time, there are certain cases where having the subsequent action pre-configured can be advantageous as explained in the subsequent description.

Preserving state enables the user to keep the parameter values corresponding to an activity, preserved in the form of an active image file. To understand this, the example of a mobile application for recharging pre-paid mobile phones may be considered. A regular user of the mobile application could be recharging some limited number of mobile numbers through the mobile application for a similar amount over a long period of time. For each of such transactions, the user will have to invoke a number of activities in the mobile operating system with reference to the corresponding mobile application. In any operating system, an activity is a single focused thing that the user can do, for example, a window or electronic page with which the user can interact. So, for completing a recharge the user will have to fetch a number of activities in a sequence, such as Main Activity (recharge app)→Recharge activity (fill details here and click ‘Recharge Now’)→Payment mode selection activity→Payment app Main activity→Final Confirmation activity, as illustrated in FIG. 5. Accordingly, a user who wants to recharge a prepaid mobile phone will most likely perform the following steps: At step 501, the user will first open a recharge application or a webpage for the same purpose. The user will then select a relevant option, such as mobile recharge from the main activity. At step 502, a mobile recharge activity will open up, wherein the user will manually enter or select relevant information, such as mobile number, mobile operator, recharge amount, etc. After that, the user will click on a recharge button for proceeding to payment; At step 503, a payment mode selection activity will open up, wherein the user can select a payment method and/or a bank and click a button to proceed further; At step 504, a payment activity will open up, wherein the user will provide his credentials and complete the payment; and At step 505, a recharge status will be show, for example, recharge successful or recharge failed.

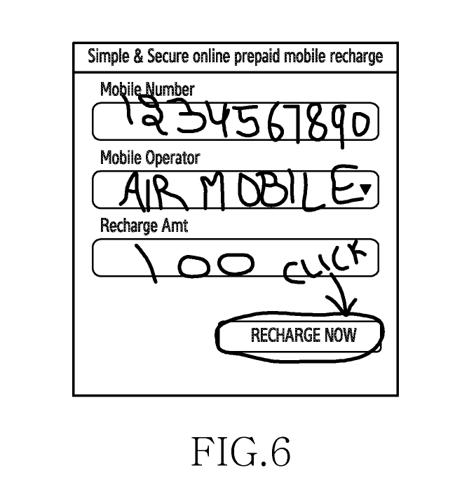

On the other hand, the user of the present invention first time will prepare an active image file that contains the state parameter, actions, activity info captured in the image file itself as shown in FIG. 6. For this, the user can take a screenshot of the underlying activity and provide input parameters for the page elements on the screen. The user can optionally provide action information for a particular state on the same image. Then the active image is saved for future reference purpose. Now whenever the user wants to perform the saved task, the user can open the active image file from gallery or file explorer and act upon it. This will send a consolidated query to an application/web server and load the output activity directly.

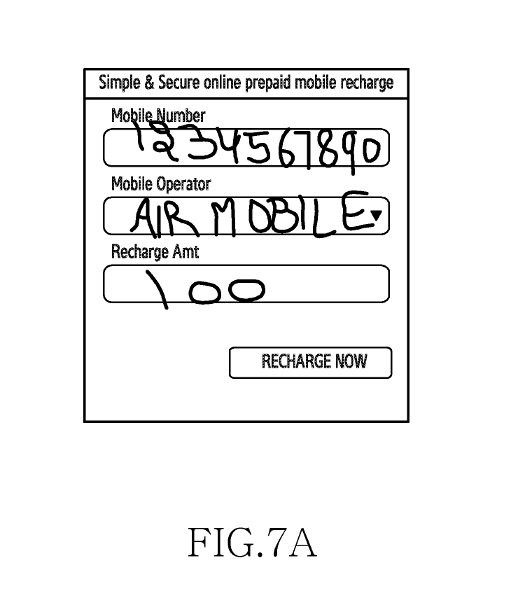

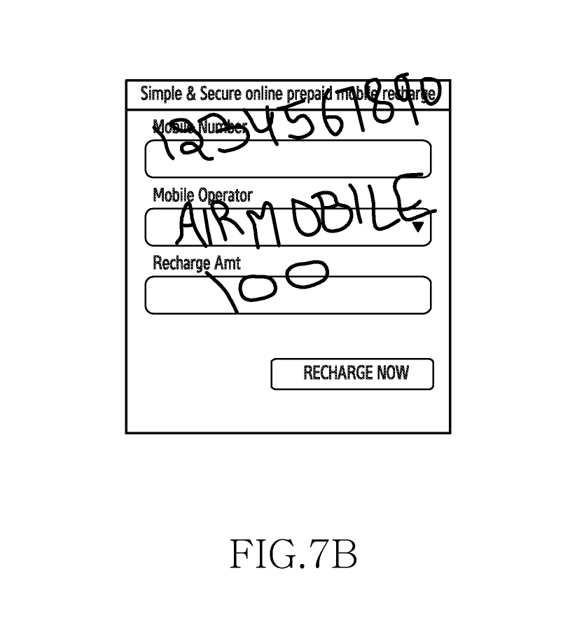

In one implementation, the user can provide the text input substantially over a text box as shown in FIG. 7A. As shown, the user will take a screenshot at the 2nd activity, i.e., Mobile recharge activity. The user can write the parameters to be preserved in the state by scribbling over the screen. The software system shall scan and detect the handwriting and use the provided input as the value for the state parameters. For example, the user could write the value for the mobile number, mobile operator and recharge amount on the image itself.

In an alternative implementation, the user does not have to type the parameter value directly necessarily above the fields as shown in FIG. 7B. The system shall detect the values inputted and check the available fields and according to a predefined criterion, such as the field type and/or aspect ratio of the input etc. This shall auto-assign a parameter value to its corresponding field. In this way, the final output image provides a state preserving the values of its parameters captured in the form of an active image file.

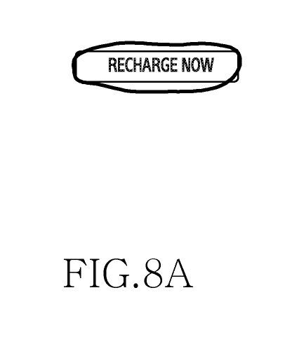

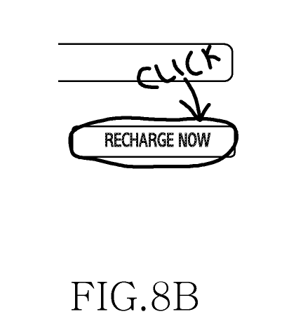

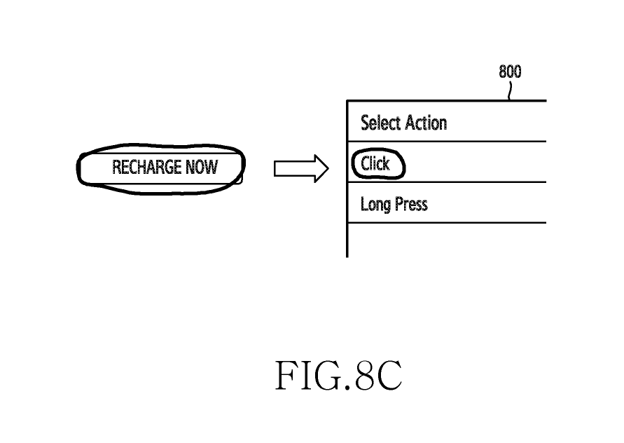

The next step after preserving the state is to have provisions for binding the subsequent actions to the currently preserved state. These subsequent actions will indicate which of the available choices is to be taken for completing the next step. For example, which bank the user selects to proceed with payment after filling up state parameters. After saving the state parameters of an activity in the form of an active image, the user may want to save the action to be performed on one or more GUI elements that would take the user to the next activity. For instance, a common action could be to click a button after auto-filling the form elements in an activity. In current example, after providing the values to the state parameters, the user may mark the desired action to be taken on any of the available objects in the screen using one of the exemplary methods shown in FIGS. 8A to 8C. More specifically, the user can mark the button, “RECHARGE NOW” as the action event that shall take the user to the next activity. This step is even though optional, it is still a great approach to directly proceed to the next activity (‘Payment mode selection’ Activity) so that redundant loading of activities up to ‘Mobile Recharge’ activity can be avoided.

For the user to be able to indicate the action, the user can highlight the corresponding form element, for instance, a button on the image file. The action may be defined in any of the following exemplary methods: (1) drawing a simple circle around the button can indicate the default (click) action to be performed on the button as shown in FIG. 8A; (2) the user can also write the click event for the button explicitly on the image as shown in FIG. 8B; (3) otherwise after the user draws a circle around the button, the system can show a pop-up window 800 of the list of all the possible actions that could be performed on that button as shown in FIG. 8C, the user can select the desired action button event from the list and system saves it along with the image file. In one implementation, if more than one actions are defined on a single activity, the user shall also be provided with the option to define order among them, for instance, write Click1, Click2, and so on, otherwise the system can explicitly ask the user to define the order.

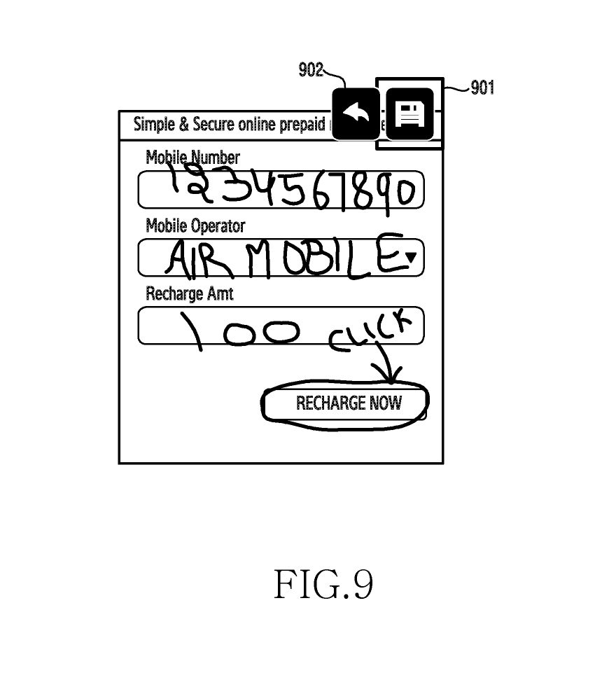

The user then proceeds to save the action to an image file. This image file can be listed separately or in the same way as the other image files. In this way, the image file is viewable in the gallery or file explorer. To this end, FIG. 9 illustrates a store button 901 that when clicked causes the relevant data to be stored along with the image. Examples of the relevant data includes, but is not limited to the state parameters, activity information, action(s) to be performed. These are saved by the system such that they can easily be retrieved at the time of image execution. Any of the following two methods could be employed for this purpose. One preferred method is to store the additional information in the form of image metadata. This provides the cross-platform movement ease. Other method is to store information in a database implemented in the file system of the computing device. In one implementation, the database could be an external database as well. The file stored in database contains reference to all the active images in the gallery. In one implementation, the gallery application may send a query to this database, each time an active image is to be executed. Additionally, the FIG. 9 also illustrates an undo button 902 that when clicked before saving the data will undo last user input on the image file.

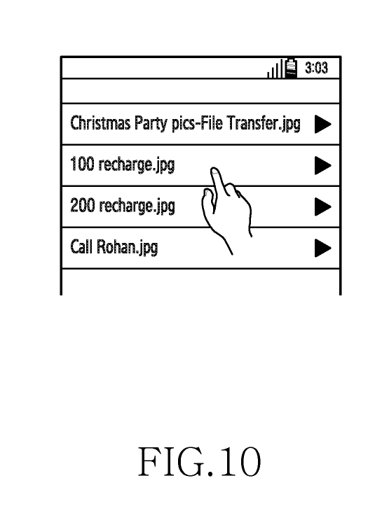

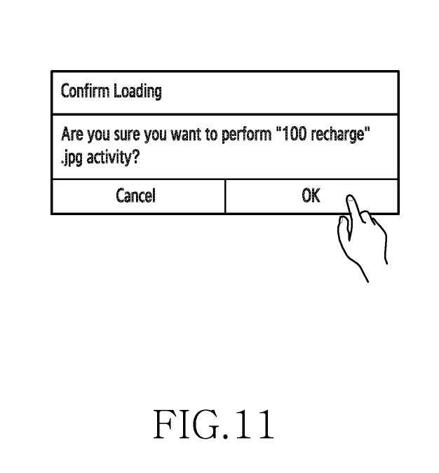

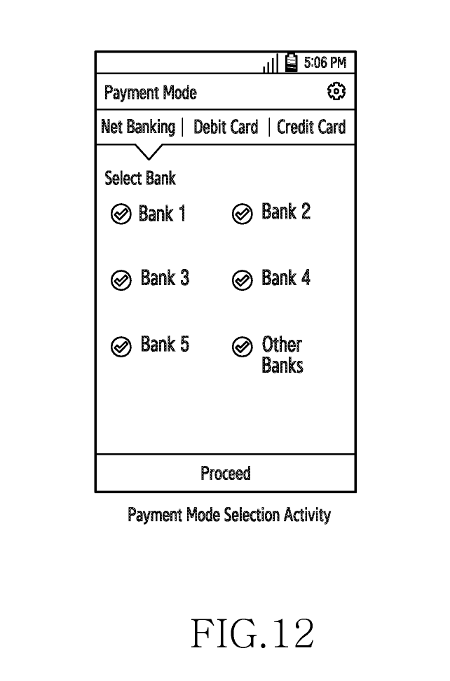

FIG. 10 illustrates the active image files saved onto the phone/computer memory that can be retrieved as and when required. These active image files when executed eliminate the need for the user going through the redundant steps that are generally repeated with same parameter values. After the user confirms to run, say, the ‘100 recharge.jpg’ file as shown in FIG. 11, he is taken directly to corresponding activity. As shown in FIG. 12, the user is taken straight to the ‘Payment mode selection’ activity. This reduces the need to perform the redundant steps that are otherwise required to be performed before reaching this particular activity.

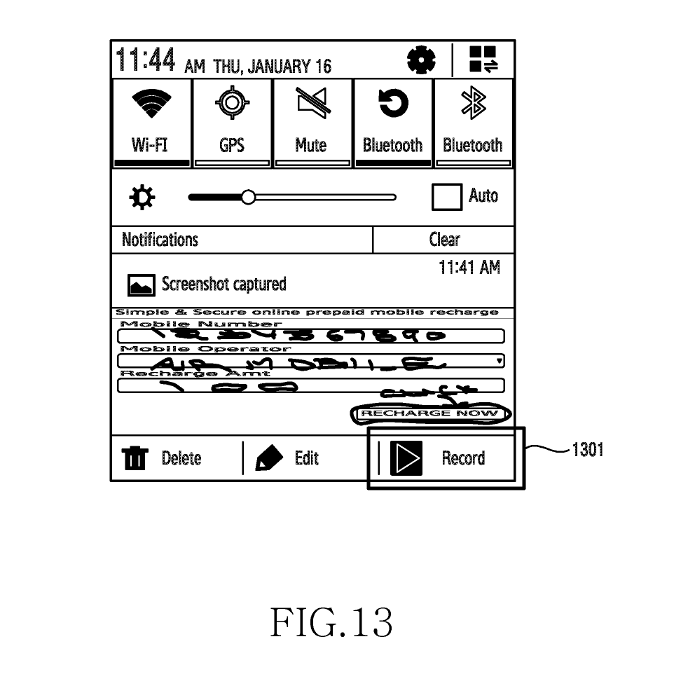

Till now only automation of one particular activity has been described. It is possible to automate a series of activities using the present invention. For this purpose, after saving one state image via the steps described above, the screenshot image can be accessed through a notification area as shown in FIG. 13. After clicking on the record option 1301, the user can keep on adding further state parameter values and subsequent action information to the image file in order to automate subsequent activities.

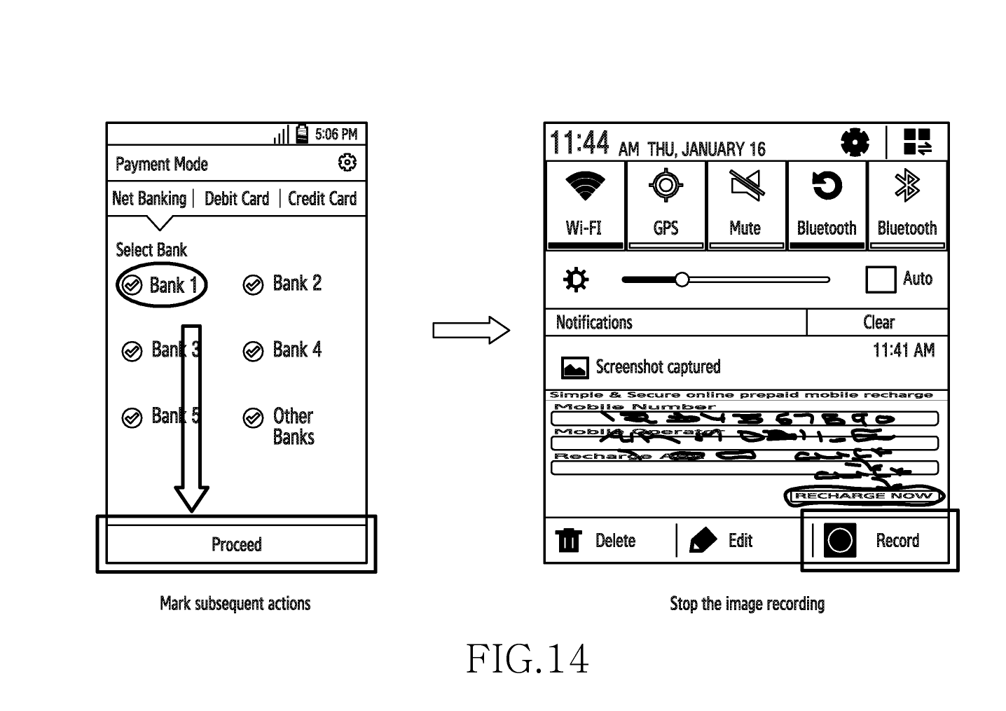

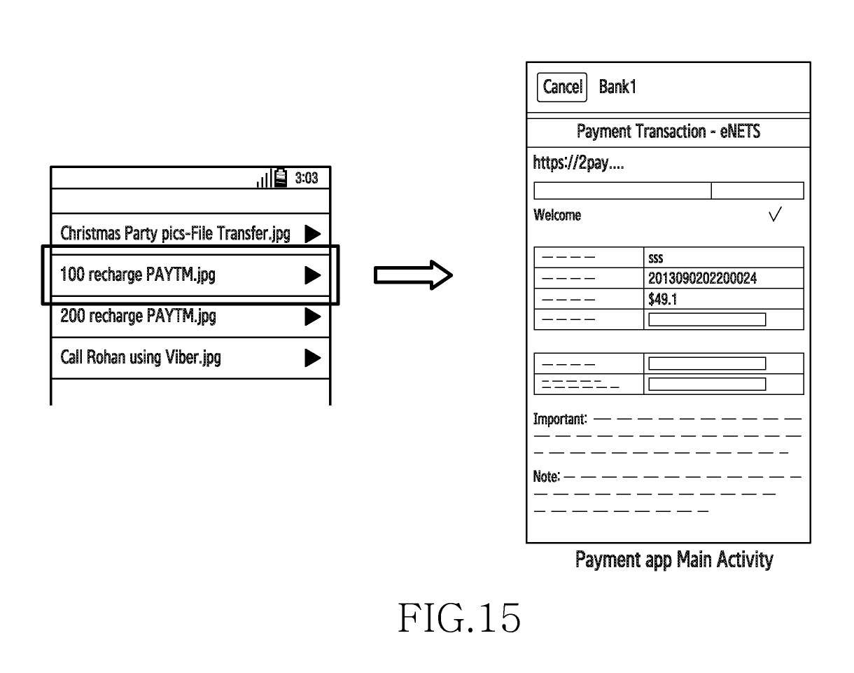

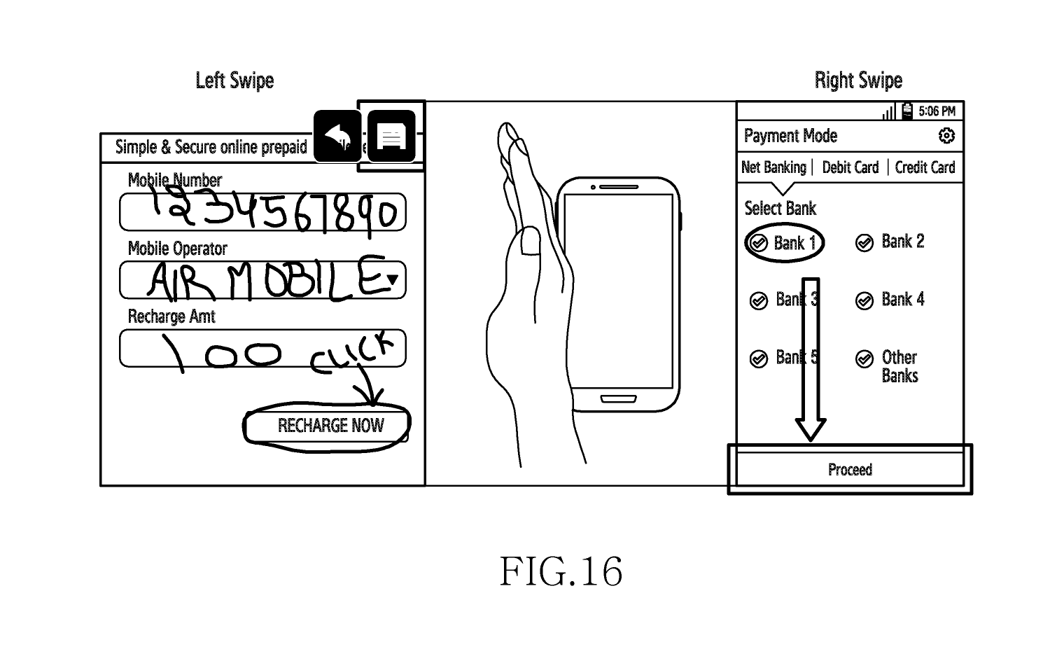

Now after clicking-on the ‘Record’ option 1301, the user can select the action in the subsequent activities. As shown in FIG. 14, the user performs some actions in the payment mode selection activity, for instance, selects Bank 1 and clicks on the “PROCEED” button. As a result, the next activity, i.e. ‘Payment app Main’ activity is now loaded in the foreground. Meanwhile, the user can go to the drop-down notification area and stop the ongoing recording. As shown in FIG. 15, this newly saved active image file allows the user to directly go to ‘Payment app Main’ activity by removing the need for the other intermediate steps. As illustrated in FIG. 16, the state images can be provided an additional capability for a user, by providing gestures for viewing the state parameters on separate state images. Which means that the user can swipe through the state images recorded in a single image file. For example, doing the swipe right gesture (in the air) on the image would allow the user to move a next state image, while swipe left here would display the previous state image.

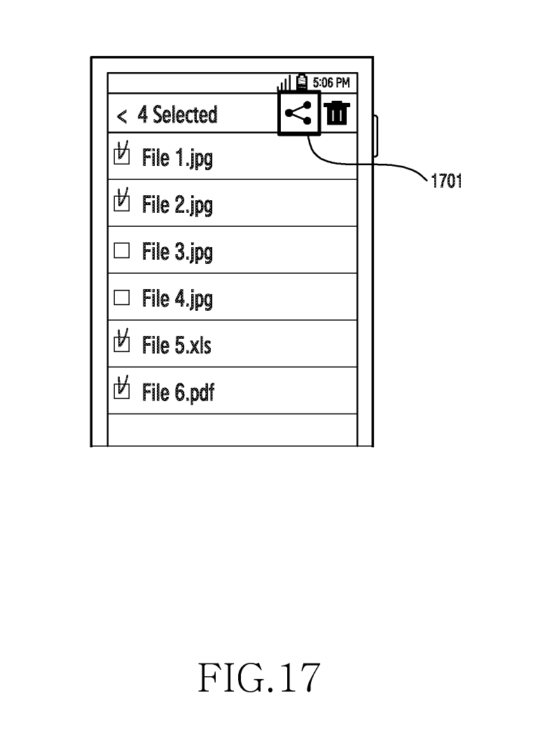

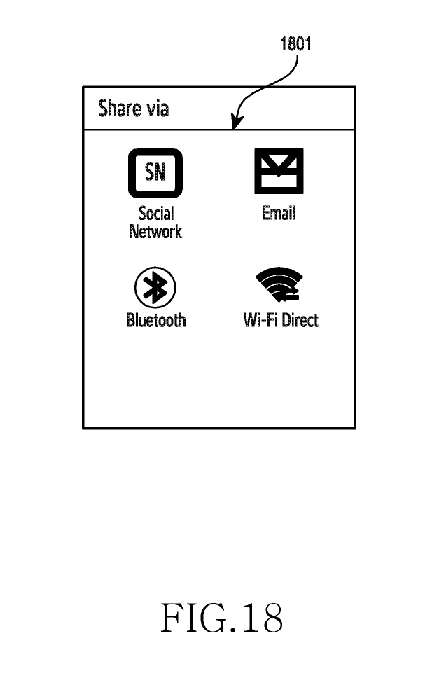

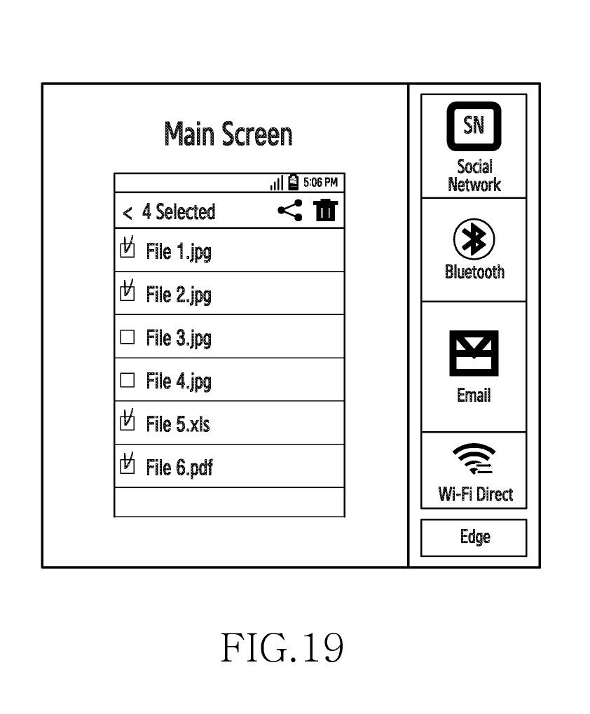

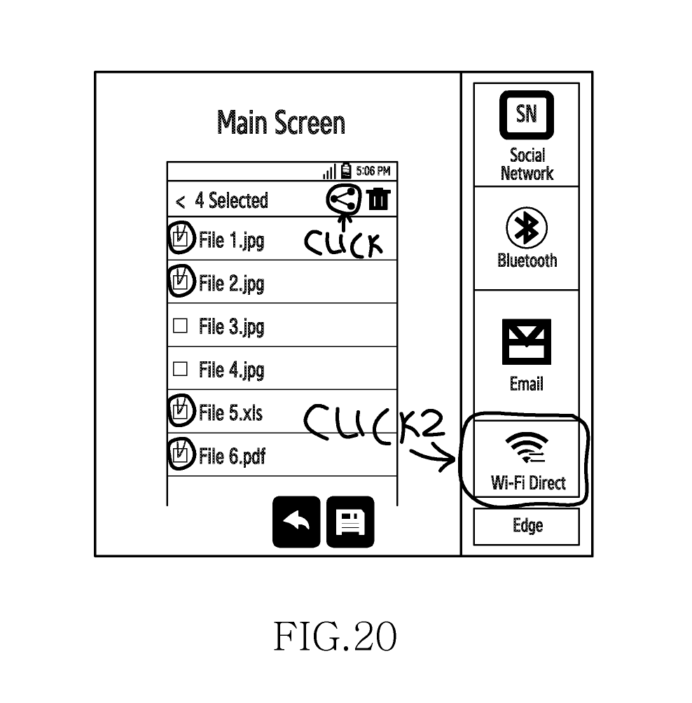

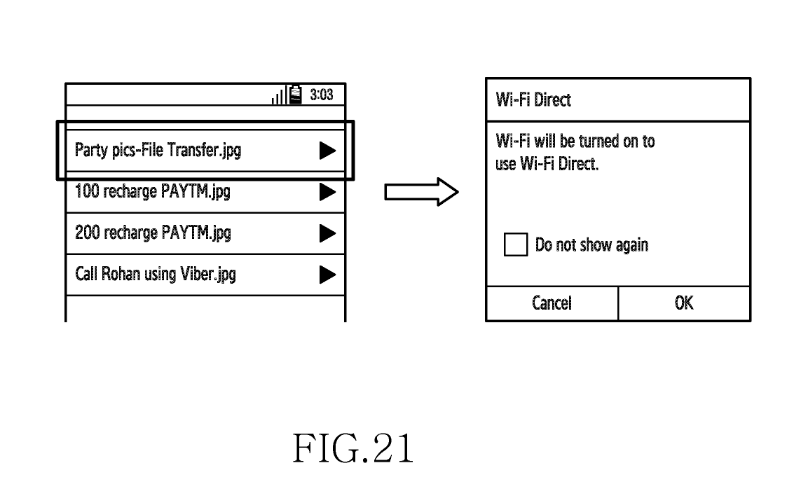

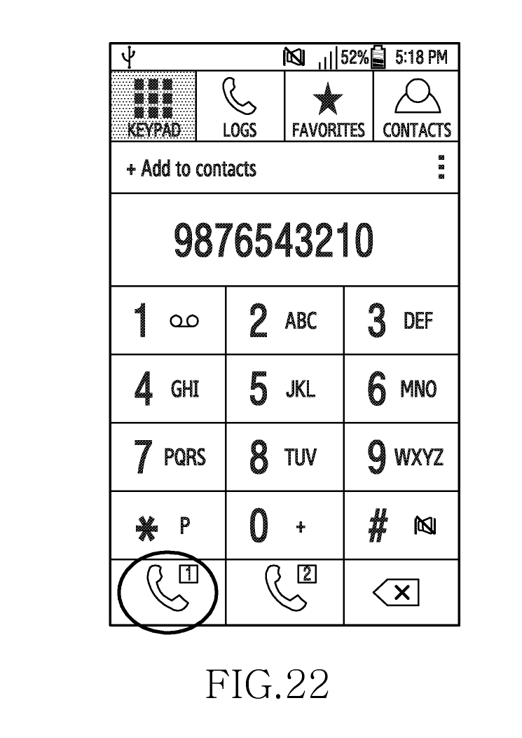

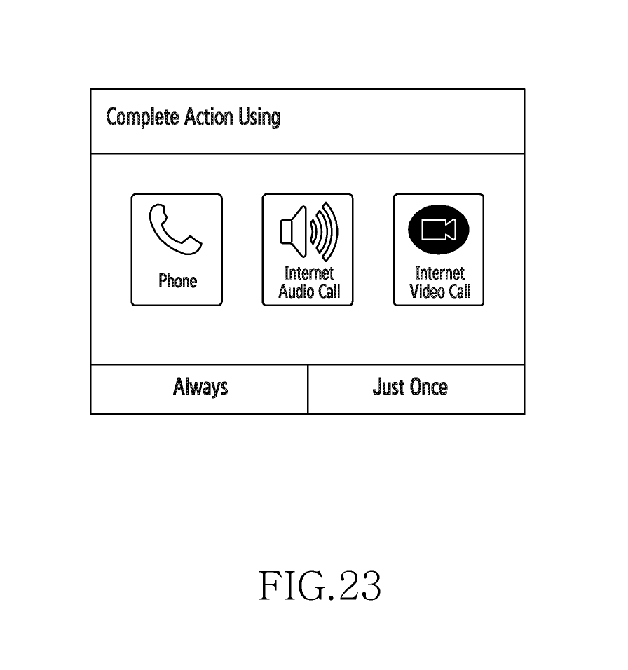

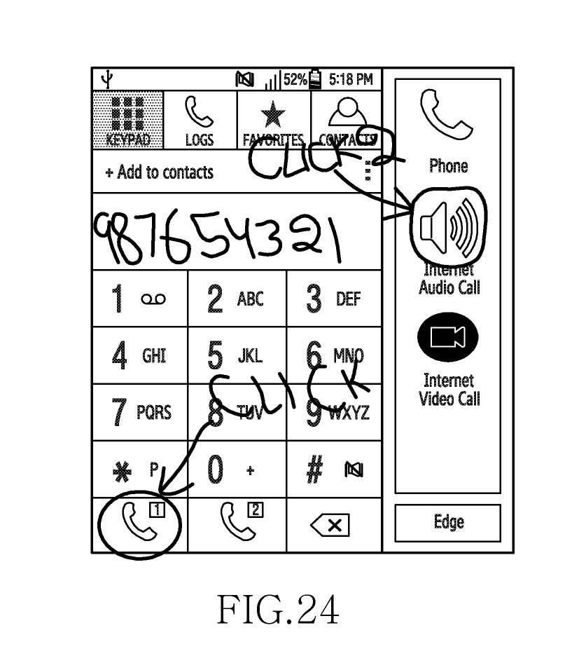

In one specific implementation of the present invention, the subsequent actions to the state image can be implemented using multi-screen hardware of a mobile device. A few state of the art devices provide the extra screen feature implemented at the edges of the mobile device. This feature can be used to save the subsequent action in a state image in a more intuitive way. To this end, FIG. 17 illustrates an example where a user is supposed to share a fixed set of files with other devices over a period of time using short range file transfer methods. Using the proposed invention, the user will mark the files that are needed to be exchanged repeatedly via short range communication technologies, for instance, Bluetooth, Wi-Fi Direct etc. and mark the action to be taken, i.e., will select ‘Share’ option 1701. After clicking on Share icon, the user is shown options 1801 to select the medium through which file needs to be shared. FIG. 18 illustrates some exemplary options 1801, such as email, social network, Bluetooth, Wi-Fi Direct, etc. The user can hold and drag the new ‘Share Via’ options window towards the ‘edge’, i.e., the secondary screen. This results into display of said options window in the secondary screen as shown in FIG. 19. Now the user can take a screenshot and save state and subsequent action information as described previously. FIG. 20 illustrates that the user has selected Files 1, 2, 5, and 6. Further, the user has first clicked on the sharing option and then on Share via Wi-Fi Direct option. Now after saving the above image, an active image file is generated using which the selected files can be directly shared without having to re-select the files again and select subsequent action as ‘Wi-Fi Direct’ as shown in FIG. 21. Similarly, a user can save a calling party number as state parameters in an image along with saving the subsequent action using the mobile phone's ‘edge’. This is illustrated in FIGS. 22-24.

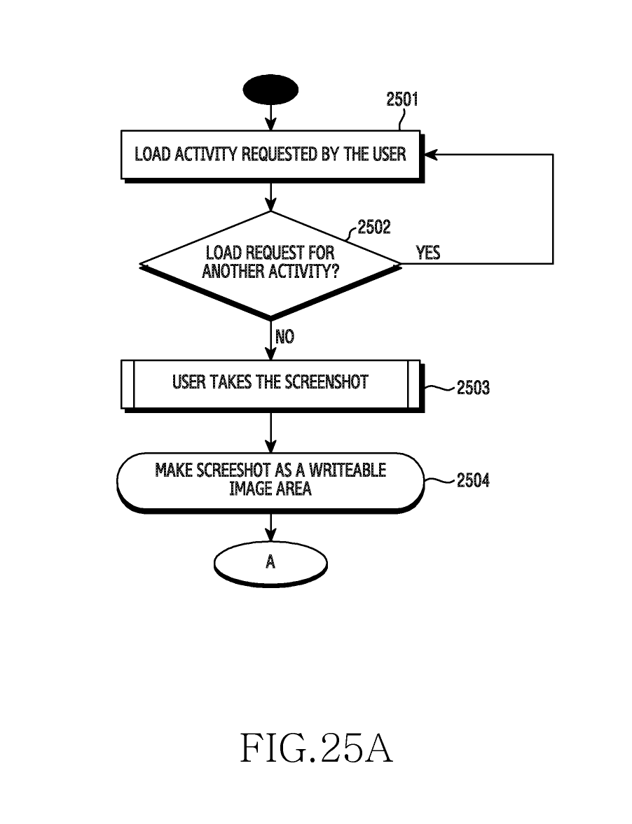

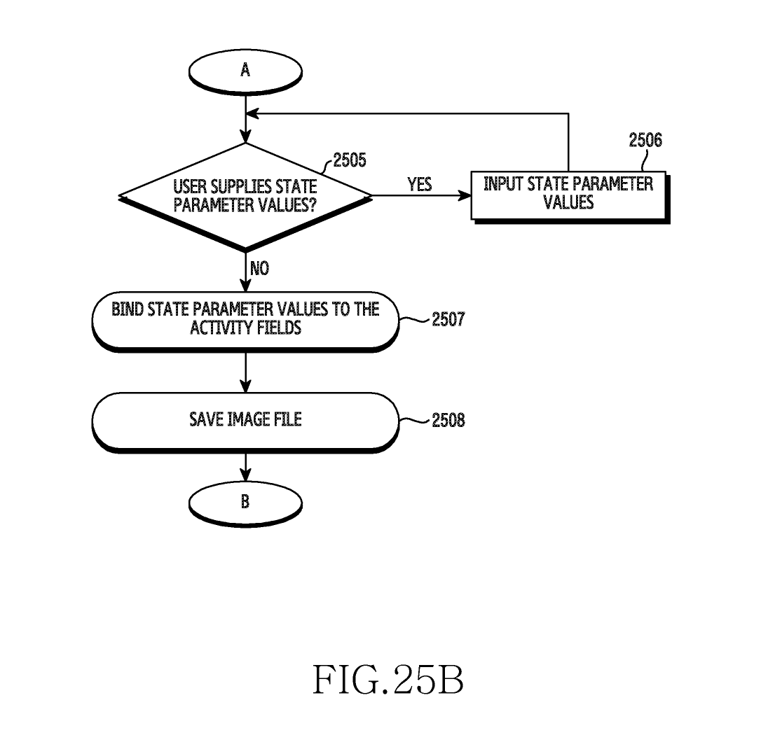

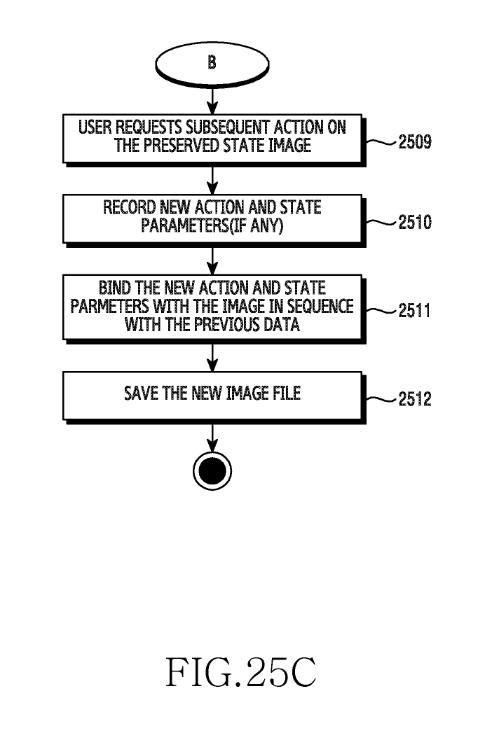

FIG. 25A to 25C illustrate a flow chart for saving image state. For saving the state parameters on the image, the user first initiates the corresponding application (Step 2501) and reaches the desired activity by moving through the desired menu options (Step 2502). After reaching the desired activity, the user takes the screenshot of the current activity (Step 2503). This generates an image file which is then made to be a writeable image area (Step 2504). After that, the system checks whether the end-user has scribbled any textual input data on the screen or highlighted the components of the captured activity by drawing all sorts of shapes and writing commands that can be parsed and understood by the system (Step 2505). Next, the user scribbles the values for the state parameters i.e. the objects of the captured activity (Step 2506). In addition, the user can also draw and write commands, i.e., actions to be executed on the same state machine. All of these values of the state parameter fields and actions are bound to specific fields on the captured activity (Step 2507). The results are saved onto the image file (Step 2508). The system shall wait and keep recoding the subsequent actions, if the end-user wishes to do so (Step 2509). The new action and state parameters are recorded (Step 2510). Further, these are bound in line with the previously captured state parameters and action (Step 2511). The results are saved in the same image file (Step 2512).

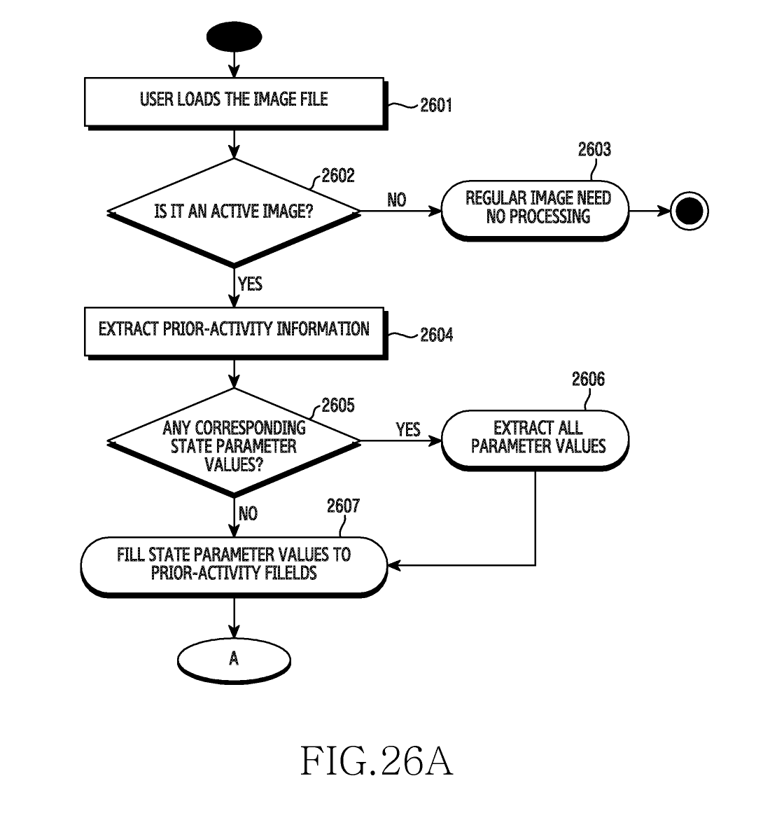

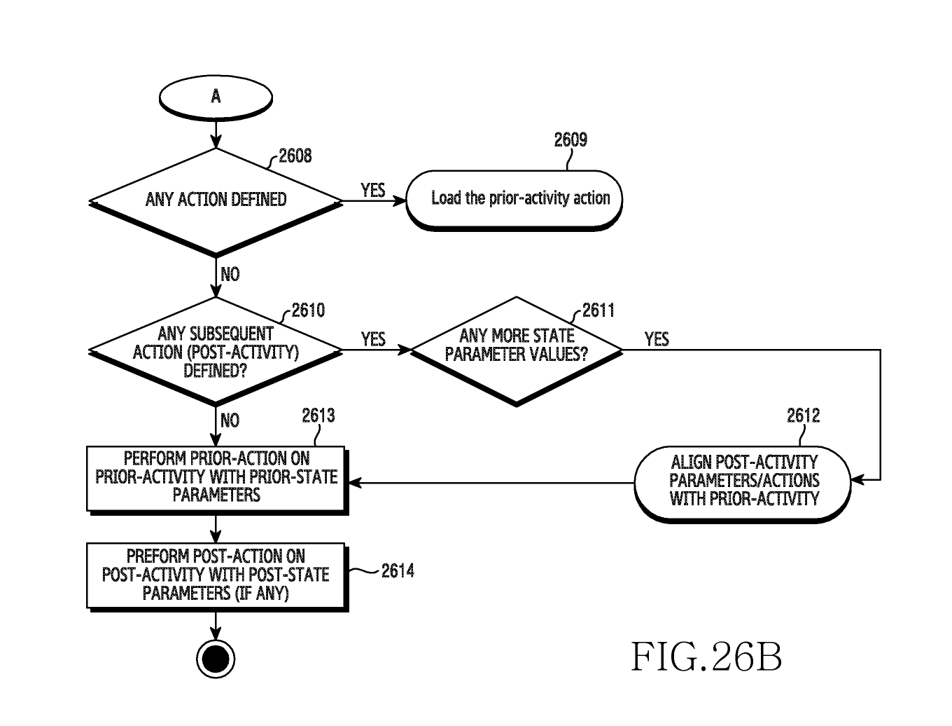

FIGS. 26A and 26B illustrate a flow chart for executing an active image. The user may navigate through the image gallery and may decide to open an image file (Step 2601). Whenever user selects the image file from the image gallery, the system checks whether it is an active image (Step 2502). If it is a regular image, the system does not perform any special processing, than just displaying the image (Step 2503). However, if the image is an active image, then the system extracts the prior activity information captured in the image (Step 2604). Next, the system checks if there are any state parameter values associated with the active image (Step 2605). If found, the system extracts all those state parameter values (Step 2606). The retrieved values are filled in the respective fields of the said prior activity (Step 2607). Further, the image is checked to find whether any subsequent action is bound with that state (Step 2608). If yes, that action is performed taking into consideration the corresponding state parameters (Step 2609). After that, the system checks whether any subsequent action (post activity) is defined (Step 2610). At the same time, the system also checks for any other state parameter values (Step 2611). Accordingly, the system aligns the post activity parameters/actions with the prior activity (Step 2612). Once all input information is checked and aligned, the system performs the prior action on prior activity with prior state parameters (Step 2613) and also performs post action on post activity with post state parameters (Step 2614) and so on.

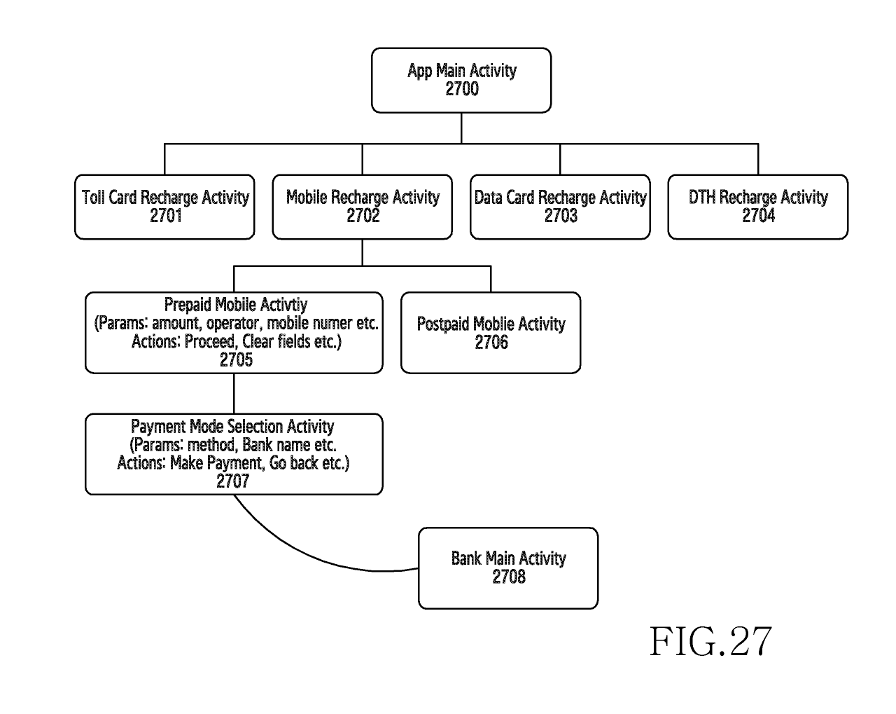

FIG. 27 illustrates an overview of various activities involved in the mobile recharge example. The main activity 2700 for the application provides hyper-links for the further sub-activities. For example, there are four sub-activities for main activity of the app, named ‘toll card recharge activity’ 2701, ‘mobile recharge activity’ 2702, ‘data card recharge activity’ 2703 and ‘DTH recharge activity’ 2704. The mobile recharge activity is further divided into two activities, i.e., ‘pre-paid mobile activity’ 2705 and ‘post-paid mobile activity’ 2706. The pre-paid activity further comprises a ‘payment mode selection activity’ 2707 from where a user can go to a ‘bank main activity’ 2708.

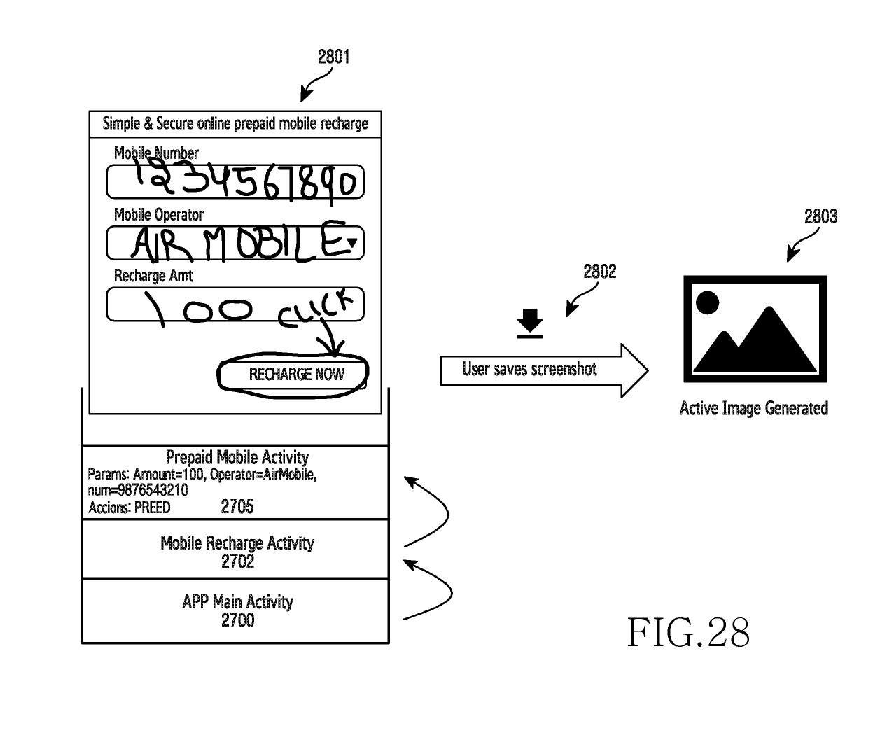

FIG. 28 illustrates an overview of the active image generation process. At first step 2801, the user first opens a ‘main activity’ 2700, then ‘Mobile Recharge Activity’ 2702, and then the ‘Prepaid Mobile Activity’ 2705. This activity 2705 has various fields, such as mobile number to be recharged, network operator name, recharge amount, etc. The corresponding actions that could be taken are: proceeding further with the recharge, going back, clearing fields, etc. At step 2802, the user takes screenshot and provides desired input for the state to be preserved and action to be taken. At step 2803, the screenshot along with the corresponding state parameters as well as the action to be taken is stored in form of an active image.

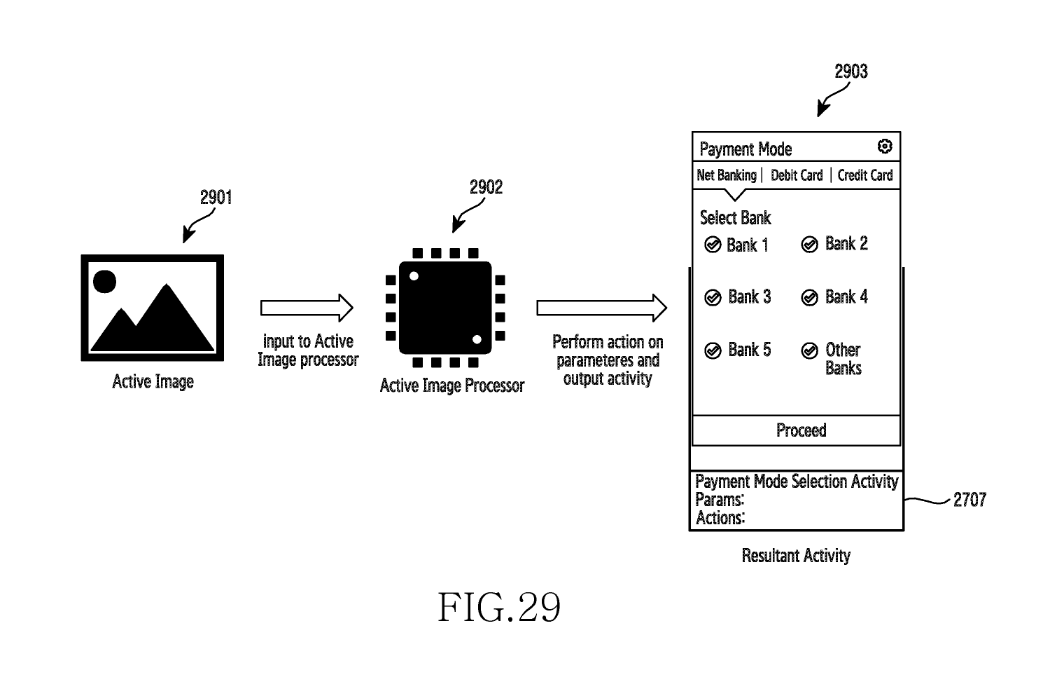

FIG. 29 illustrates an overview of the active image utilization process. At step 2901, the user opens the active image file. At step 2902, an active image process executes the active image file. As a result, the corresponding activity is performed using the stored state parameter values upon which the corresponding action is taken. At step 2903, the resultant activity, for instance, ‘payment mode selection activity’ 2707 is displayed on the screen.

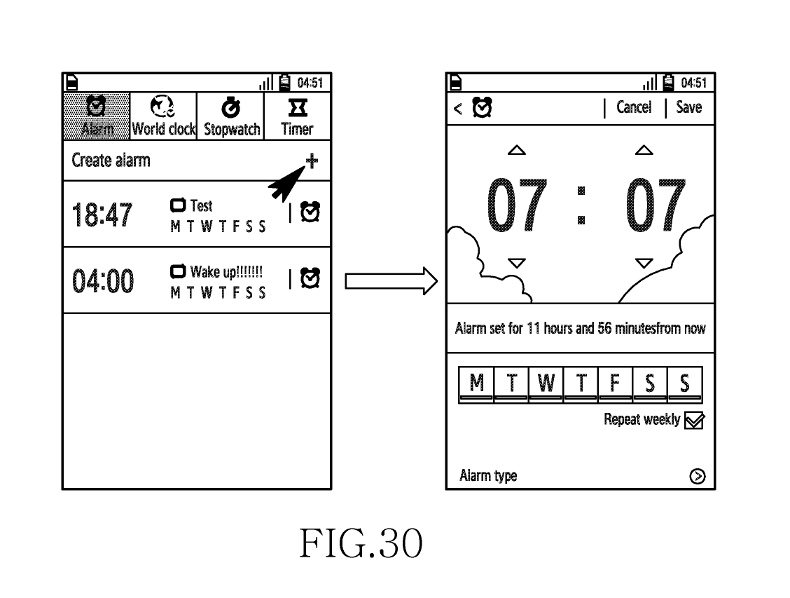

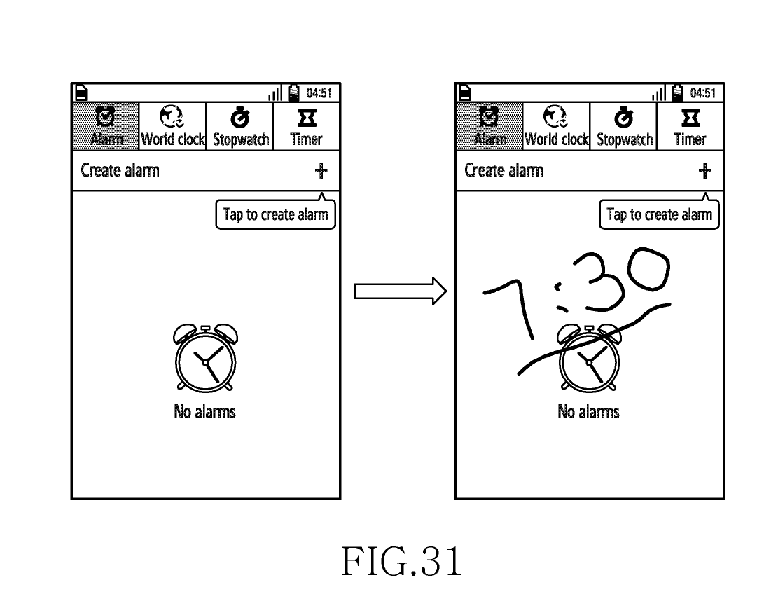

There can be end-user scenarios where saving the state on the image in the form of parameter values could be skipped. The user could just take a screenshot of the activity and provide the parameter values later on at the time user wants to run the operation. For example, imagine a user going to the alarm app and clicking on ‘Create alarm’ as illustrated in FIG. 30. This would take the user from first activity, say ‘Activity 1’, to second activity ‘Activity 2’. Using the present invention, the user can take a screenshot at the clock app as shown in FIG. 31. Next, the user can type on the screenshot and provide the state parameter values, i.e., alarm time input on the writeable area. As shown, this would set the new alarm set at 07:30 on the mobile phone.

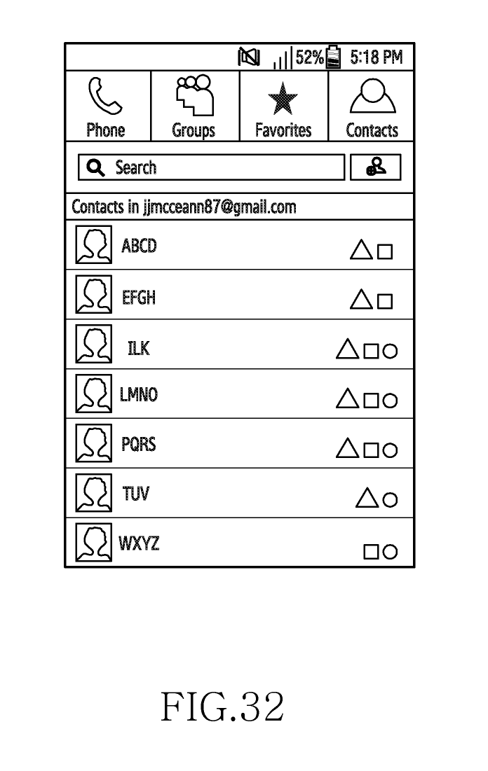

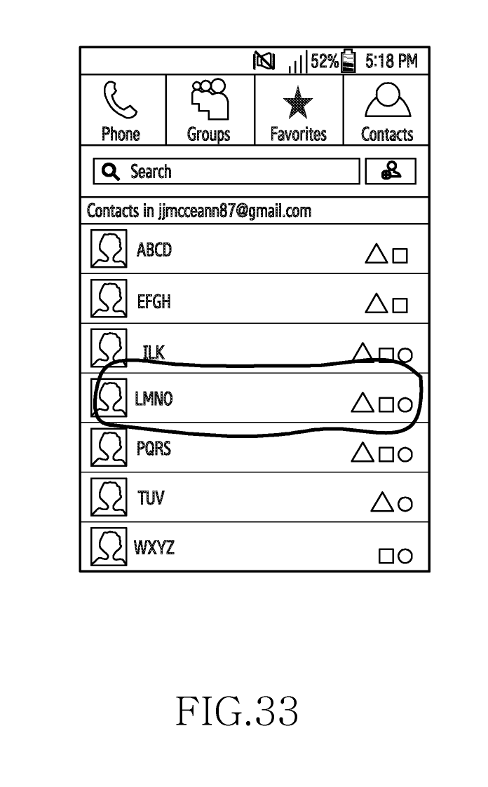

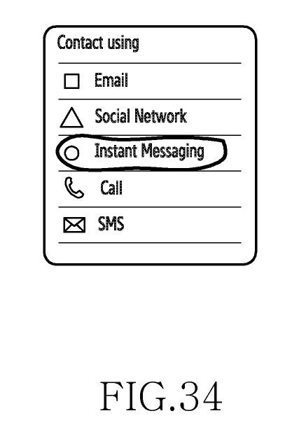

In one implementation, the present invention can implement context-aware state/activity preservation. For this purpose, the active image processor can be configured to have context awareness for native applications. FIG. 32 illustrates a screenshot of contacts native application taken by user. This image file, upon post processing input supplied by the user, can provide user-specific contact options as explained below. For example, the user can select person name LMNO as illustrated in FIG. 33. As indicated in FIGS. 32 and 33, person LMNO and the user are connected through Email, social Network, and Instant Messaging. The screen shown in FIG. 34 pops up for user contact method selection, wherein user can mark any one of contact method, say instant messaging, and that is bound with said screenshot taken by the user and then stored as an actionable image. Whenever the user wants to contact the person LMNO through instant messaging, the user can execute said actionable image. In this way, the user can automate any activity that otherwise requires redundant steps to be performed every time.

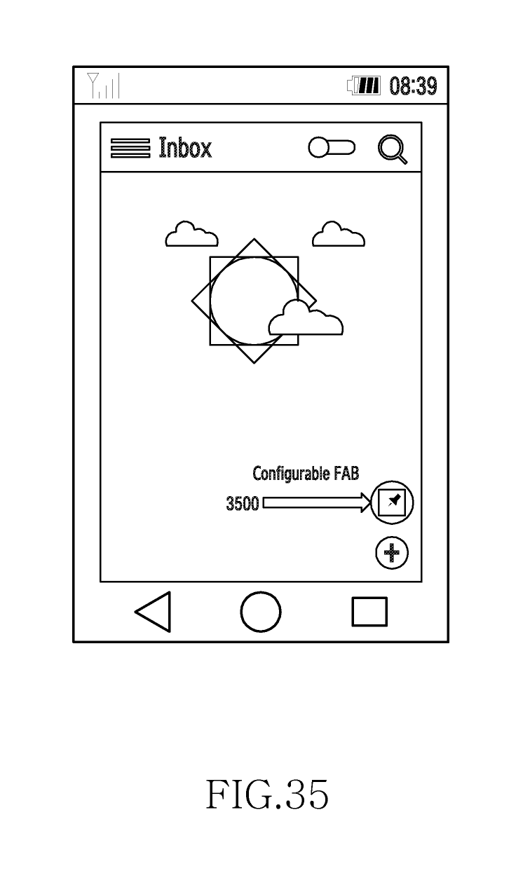

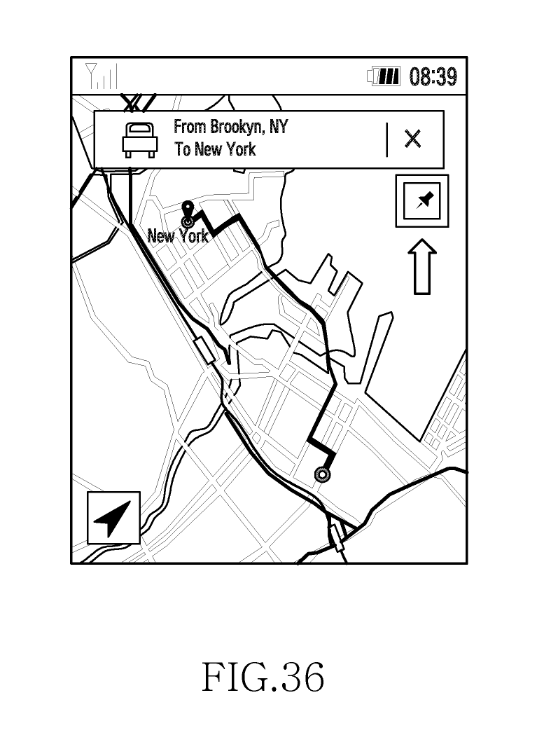

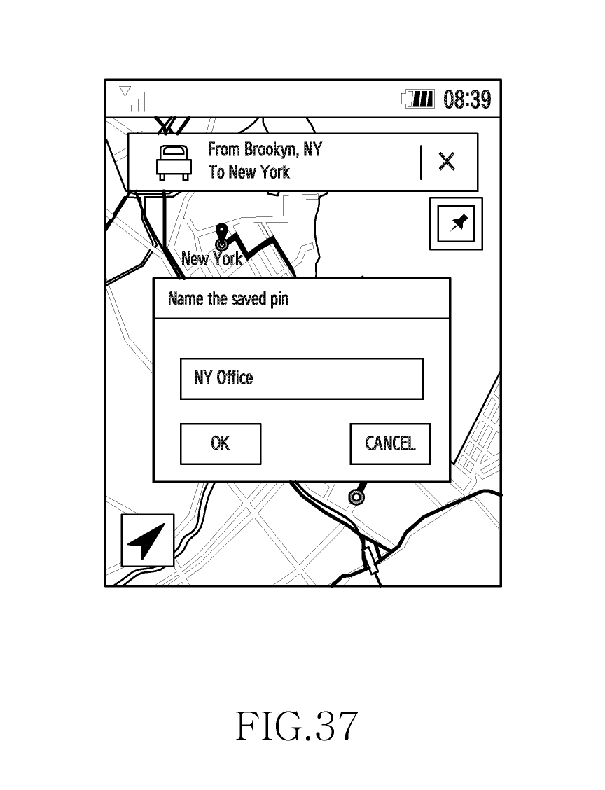

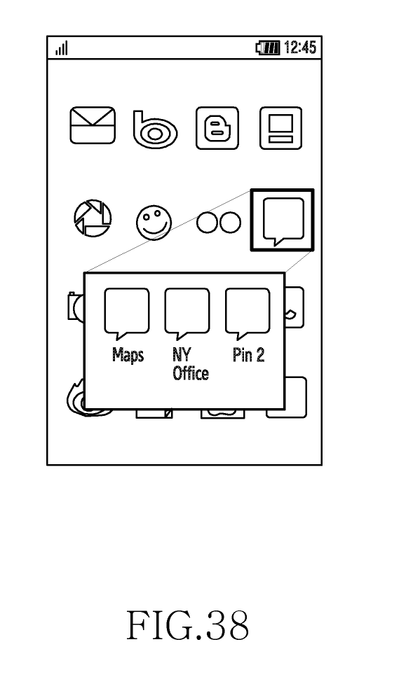

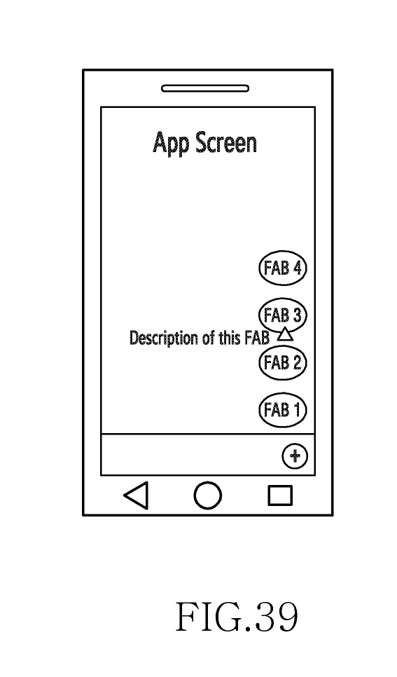

In one implementation, the present invention provides the end user with an interface with capability to self-define new execution paths via the application short-cuts. For this purpose, the proposed system uses the Floating Action Buttons, also known as FABs. FIG. 35 illustrates a configurable FAB 3500. While using an application, the FAB can be triggered at any screen. When the user taps on this configurable FAB, the application saves this execution path and generates a new short-cut for this path. For example, a user can search for his a particular direction on a map application, then pin the current path using the configurable FAB as shown in FIGS. 36 and 37. This would convert the map application icon in phone gallery to change to an expandable utility with icons for each saved shortcut along with the default application icon as shown in FIG. 38. Similarly, a prepaid recharge screen can be pinned using the configurable FAB. An application for recharge shall provide a configurable FAB at the end of a recharge process, if the user pins the path, the recharge amount, user number, bank used etc. It shall be pinned and a new shortcut shall be created along with the recharge app icon. In one implementation, this approach can be extended by providing the shortcut themselves in the form of FABs on the application screen as shown in FIG. 39. These FABs can also be displayed on a secondary screen in case the phone hardware has such capability.

In various embodiments as above-mentioned, an image file including both text input and a screenshot of an electronic page is used. However, other types of files may be used as a tool for automatic insertion of text in an electronic page according to other embodiments. For example, a text file may be used as a tool for the automatic insertion of text in the electronic page. Specifically, an embodiment where the text file is used as below.

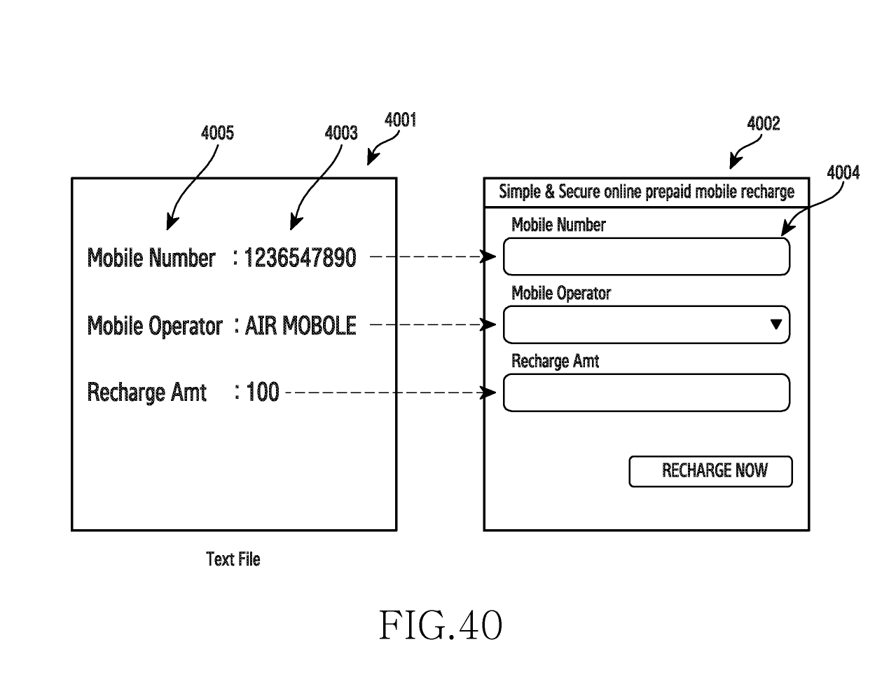

FIG. 40 illustrates a text file 4001 for automatic insertion of text in the electronic page 4002 in another embodiment of the present invention. The form elements 4004 may be form UI elements of the electronic page 4002. Each of the text input 4003 included in the text file 4001 corresponds with each of the form elements 4004 of the electronic page 4002. In other words, each of the text input 4003 included in the text file 4001 connects with each of the form elements 4004 of the electronic page 4002, using an identifier 4005. The identifier 4005 may be an indicator, or the like that is used for classification. Each of the identifiers indicates each of the form elements 4004 of the electronic page 4002. For example, an identifier “Mobile Number” indicates the form elements “Mobile Number”. In this case, when the user selects the text file 4001, the form element “Mobile Number” is filled with a text “1234567890” that corresponds to the identifier “Mobile Number”. The user may save the text file 4001 based on the detected text input 4003.

When the user opens the saved text file 4001 from the file explorer, a consolidated query is transmitted to an application/web server associated with the electronic page 4002. The consolidated query is a request to open an electronic page having form elements filled with text data related to the text input 4003. In response the transmitting the consolidated query, the user may obtain the electronic page having pre-filled with the text data related to the text input 4003. Although it is not shown that an action event taking the user to the next activity is performed using a button “RECHARGE NOW” of the electronic page 4002, the action event may be performed using a click for bringing a next electronic page. The click may be performed by an instruction that is included in the text file 4001. In case of using the instruction, the location of a click button may be defined as an identifier, an indicator, coordinates, or the like that may assign the location of a click.

While certain present preferred embodiments of the present invention have been illustrated and described herein, it is to be understood that the present invention is not limited thereto. Clearly, the present invention may be otherwise variously embodied, and practiced within the scope of the following claims.

What is claimed is:

1. A method for automatic insertion of text into an electronic page in an electronic device, the method comprising:
detecting a selection of an electronic file having information comprising text data corresponding to at least one form user interface (UI) element of an electronic page and a link to the electronic page; and
obtaining the electronic page in a state that the at least one form UI element is filled with the text data.

2. The method of claim 1, wherein the obtaining the electronic page in the state that the at least one form UI element is filled with the text data comprises:
transmitting a request signal to a server associated with the electronic page;
receiving the electronic page; and
filling the text data into the at least one form UI element.

3. The method of claim 1, wherein the electronic file comprises a text file, and
wherein the text file comprises at least one indicator indicating the at least one form UI element and the text data.

4. The method of claim 1, wherein the information further comprises at least one of a screenshot of the electronic page and an action that is performed on a graphical user interface (GUI) element of the electronic page.

5. The method of claim 4, further comprising:
performing the action on the GUI element of the electronic page in the state that the at least one form UI element is filled with the text data.

6. The method of claim 5, further comprising:
receiving another electronic page resulting from the action performed on the GUI element of the electronic page in the state that the at least one form UI element is filled with the text data.

7. The method of claim 1, wherein the text data is associated with the at least one form UI element based on a predefined criterion when the text data is a handwritten input.

8. The method of claim 7, wherein the predefined criterion comprises at least one of a selection of the at least one form UI element, a proximity of the text data to the at least one form UI element, a type of the text data and a content of the text data.

9. The method of claim 1, wherein the electronic file is generated by capturing a screenshot of the electronic page having the at least one form UI element and detecting a user input for the text data corresponding to the at least one form UI element of the electronic page.

10. The method of claim 9, wherein the electronic file is generated by detecting a user input for defining an action that is performed on a GUI element of the electronic page connecting the action with the GUI element of the electronic page and adding information related to the connecting.

11. An apparatus for automatic insertion of text into an electronic page in an electronic device, the apparatus comprising a processor, wherein the processor is configured to control to:
detect a selection of an electronic file having information comprising a link to an electronic page and text data corresponding to at least one form user interface (UI) element of the electronic page; and
obtain the electronic page in a state that the at least one form UI element is filled with the text data.

12. The apparatus of claim 11, wherein the apparatus further comprises a transceiver, and
wherein the transceiver is configured to:
transmit a request signal to a server associated with the electronic page;
receive the electronic page; and
fill the text data into at least one form UI element.

13. The apparatus of claim 11, wherein the electronic file comprises a text file, and
wherein the text file comprises, at least one indicator indicating the at least one form UI element, and the text data.

14. The apparatus of claim 11, wherein the information further comprises at least one of a screenshot of the electronic page and an action that is performed on a graphical user interface (GUI) element of the electronic page.

15. The apparatus of claim 14, wherein the processor is configured to perform the action on the GUI element of the electronic page in the state that the at least one form UI element is filled with the text data.

16. The apparatus of claim 15, wherein the processor is configured to control to receive another electronic page resulting from the action performed on the GUI element of the electronic page in the state that the at least one form UI element is filled with the text data.

17. The apparatus of claim 11, wherein the text data is associated with the at least one form UI element based on a predefined criterion when the text data is a handwritten input.

18. The apparatus of claim 17, wherein the predefined criterion comprises at least one of a selection of the at least one form UI element, a proximity of the text data to the at least one form UI element, a type of the text data and a content of the text data.

19. The apparatus of claim 11, wherein the electronic file is generated by capturing a screenshot of the electronic page having the at least one form UI element and detecting a user input for the text data corresponding to the at least one form UI element of the electronic page.

20. The apparatus of claim 19, wherein the electronic file is generated by detecting a user input for an action that is performed on a GUI element of the electronic page, connecting the action with the GUI element of the electronic page and adding information related to the connecting.
